(19) United States
(12) Patent Application Publication
(10) Pub. No.: US 2021/0129868 A1
(43) Pub. Date: May 6, 2021

(54) COMPUTER AIDED DRIVING

(71) Applicant: VAYAVISION SENSING LTD., OR YEHUDA (IL)

(72) Inventor: Youval Nehmadi, Nili (IL)

(21) Appl. No.: 16/484,298

(22) PCT Filed: Jan. 30, 2018
(86) PCT No.: PCT/IL2018/050102

§ 371 Date: Aug. 7, 2019

Related U.S. Application Data
(60) Provisional application No. 62/457,821, filed on Feb. 11, 2017.
(60) Provisional application No. 62/455,656, filed on Feb. 7, 2017.

(51) Int. Cl. B60W 60/00; G06K 9/00; G06F 16/9035

(52) U.S. Cl. CPC B60W 60/0059; B60W 60/001; G06K 9/00805; B60W 2554/4029; B60W 2554/4049; B60W 2554/4041; G06F 16/9035

(57) ABSTRACT

A method for operating a vehicle, the method may include sensing, by at least one sensor of the vehicle, an environment of the vehicle, the environment comprises a dynamic object; estimating an estimated impact of the dynamic object on a future propagation of the vehicle; wherein the estimating is responsive to information that is stored in a dynamic database, wherein the information is about an estimated behavior of the dynamic object; and performing a driving related operation of the vehicle based on the estimated impact.

### CROSS REFERENCE

This application claims priority from US provisional patent Ser. No. 62/457,821 filing date Feb. 11, 2017 and from U.S. provisional patent Ser. No. 62/455,656 filing date Feb. 6, 2017, both incorporated in their entirety.

### BACKGROUND

Autonomous vehicles and driver aiding systems are expected to reduce the load imposed on human drivers. There is a growing need to improve the autonomous vehicle and driver aiding systems.

### SUMMARY

There may be provided systems, methods and computer program products as illustrated in the specification, the claims and the drawings.

There may be provided a method for operating a vehicle, the method may include sensing, by at least one sensor of the vehicle, an environment of the vehicle, the environment may include a dynamic object; estimating an estimated impact of the dynamic object on a future propagation of the vehicle; wherein the estimating is responsive to information that is stored in a dynamic database, wherein the information is about an estimated behavior of the dynamic object; and performing a driving related operation of the vehicle based on the estimated impact.

There may be provided a method for of a vehicle, the method may include repeating, for each location out of multiple locations, the steps of: selecting which type of vehicle sensor, out of multiple types of vehicle sensors, to use for sensing an environment of the vehicle when the vehicle is located at the location; and using at least one selected type of vehicle sensor to sense the environment of the vehicle when the vehicle is located at the location; wherein the using may include sensing signals associated with multiple points of interest within the environment.

There may be provided a method for maintaining a dynamic database, the method may include receiving, from a first plurality of vehicles and information about different locations of the multiple vehicles; maintaining the dynamic database, wherein the dynamic database may include statistics related to behaviors of dynamic objects within the different locations; and distributing relevant portions of the dynamic database to a second plurality of vehicles.

There may be provided a method for assisting in an update of dynamic database, the method may include receiving, by a vehicle, a portion of the dynamic database; wherein the dynamic database may include statistics related to behaviors of dynamic objects within the different locations; searching for a mismatch between the content of the portion of the dynamic database and sensed information that is sensed by the vehicle; and reporting the mismatch to a computerized entity that participates in a maintaining of the dynamic database.

There may be provided a computer program product that may store instructions that once executed by a computerized system that is installed in a vehicle, causes the computerized system to: sense, by at least one sensor of the computerized system, an environment of the vehicle, the environment may include a dynamic object; estimate an estimated impact of the dynamic object on a future propagation of the vehicle; wherein the estimating is responsive to information that is stored in a dynamic database, wherein the information is about an estimated behavior of the dynamic object; and perform a driving related operation of the vehicle based on the estimated impact.

There may be provided a computer program product that may store instructions that once executed by a computerized system that is installed in a vehicle, causes the computerized system to: repeat, for each location out of multiple locations, the steps of: selecting which type of vehicle sensor, out of multiple types of vehicle sensors, to use for sensing an environment of the vehicle when the vehicle is located at the location; and using at least one selected type of vehicle sensor to sense the environment of the vehicle when the vehicle is located at the location; wherein the using may include sensing signals associated with multiple points of interest within the environment.

There may be provided a computer program product that may store instructions that once executed by a computerized system that is positioned outside a vehicle, causes the computerized system to: receive, from a first plurality of vehicles and information about different locations of the multiple vehicles; maintain the dynamic database, wherein the dynamic database may include statistics related to behaviors of dynamic objects within the different locations; and distribute relevant portions of the dynamic database to a second plurality of vehicles.

There may be provided a computer program product that may store instructions that once executed by a computerized system that is positioned outside a vehicle, causes the computerized system to: receive a portion of the dynamic database; wherein the dynamic database may include statistics related to behaviors of dynamic objects within the different locations; search for a mismatch between the content of the portion of the dynamic database and sensed information that is sensed by the vehicle; and report the mismatch to a computerized entity that participates in a maintaining of the dynamic database.

There may be provided a computerized system that is installed in a vehicle, wherein the computerized system may include at least one sensor that is configured to sense an environment of the vehicle, the environment may include a dynamic object; and a processor that is configured to (a) estimate an estimated impact of the dynamic object on a future propagation of the vehicle; wherein the estimating is responsive to information that is stored in a dynamic database, wherein the information is about an estimated behavior of the dynamic object; and (b) perform a driving related operation of the vehicle based on the estimated impact.

There may be provided a computerized system that is installed in a vehicle, wherein the computerized system may include a processor and multiple types of sensors; wherein the computerized system is configured to repeat, for each location out of multiple locations, the steps of: selecting, by the processor, which type sensor, out of the multiple types of sensors, to use for sensing an environment of the vehicle when the vehicle is located at the location; and use at least one selected type of sensor to sense the environment of the vehicle when the vehicle is located at the location; wherein the using may include sensing signals associated with multiple points of interest within the environment.

There may be provided a computerized system that positioned outside a vehicle, that may include a communication unit and a processor; wherein the communication unit is configured to receive, from a first plurality of vehicles and information about different locations of the multiple vehicles; wherein the processor is configured to maintain the dynamic database, wherein the dynamic database may include statistics related to behaviors of dynamic objects within the different locations; and wherein the communication unit is configured to distribute relevant portions of the dynamic database to a second plurality of vehicles.

There may be provided a computerized system that positioned outside a vehicle, the computerized system may include a communication unit and a processor; wherein the communication unit is configured to receive a portion of the dynamic database; wherein the dynamic database may include statistics related to behaviors of dynamic objects within the different locations; wherein the processor is configured to search for a mismatch between the content of the portion of the dynamic database and sensed information that is sensed by the vehicle; and wherein the communication unit is configured to report the mismatch to a computerized entity that participates in a maintaining of the dynamic database.

There may be provided a method for monitoring a vehicle and operating another vehicle, the method may include monitoring, by at least one sensor of the other vehicle, a movement of the vehicle; wherein the vehicle differs from the other vehicle; estimating, by a computer of the other vehicle, based on the movement of the first vehicle and a model of the vehicle, an estimated interaction between a driver of the vehicle and the vehicle; determining a status of the driver based on the estimated interaction; estimating an estimated impact of the vehicle on a future propagation of the other vehicle; and performing a driving related operation of the other vehicle based on the estimated impact.

There may be provided a method for monitoring a vehicle and operating another vehicle, the method may include monitoring by at least one sensor of the other vehicle, a dynamic behavior of a vehicle; wherein the vehicle differs from the other vehicle; perceiving by a computer, a dynamic behavior of the vehicle; estimating the state of the vehicle; estimating the interaction between the vehicle and the other vehicle, and based on the estimated state and the estimated interaction, performing a driving related operation of the other vehicle.

There may be provided a method for estimating a future behavior of a vehicle and operating another vehicle, the method may include monitoring, during a monitoring period and by at least one sensor of the other vehicle, a movement of the vehicle; wherein the vehicle differs from the other vehicle; attempting to predict a future behavior of the vehicle based on a combination of at least two elements out of (a) light signals generated by the other vehicle during the monitoring period, (b) vehicle velocities and accelerations during the monitoring periods, and (c) spatial relationship between the vehicle and traffic lane during the monitoring period (d) an environment of the vehicles during the monitoring period; estimating an estimated impact of the vehicle on a future propagation of the other vehicle; and performing a driving related operation of the other vehicle based on the estimated impact.

There may be provided a method for operating a vehicle, the method may include receiving, by the vehicle, from at least one entity outside the vehicle, a request to change a mode of operation of the vehicle from a non-autonomous driving mode to an autonomous driving mode; determining, by a vehicle computer, whether to change the mode of operation; and when determining to change the mode of operation then changing the mode of operation of the vehicle from the non-autonomous driving mode to the autonomous driving mode.

There may be provided a computer program product that may store instructions that once executed by a computerized system that is positioned inside an other vehicle, causes the computerized system to: monitor a movement of a vehicle; wherein the vehicle differs from the other vehicle; estimate, based on the movement of the vehicle and a model of the vehicle, an estimated interaction between the driver and the vehicle; determine a status of the driver based on the estimated interaction; estimate an estimated impact of the vehicle on a future propagation of the other vehicle; and perform a driving related operation of the other vehicle based on the estimated impact.

There may be provided a computer program product that may store instructions that once executed by a computerized system that is positioned inside an other vehicle, causes the computerized system to: monitor a dynamic behavior of a vehicle; wherein the vehicle differs from the other vehicle; perceive a dynamic behavior of the vehicle; estimate a state of the vehicle; estimate an interaction between the vehicle and the other vehicle, and based on the estimated state and the estimated interaction, perform a driving related operation of the other vehicle.

There may be provided a computer program product that may store instructions that once executed by a computerized system that is positioned inside an other vehicle, causes the computerized system to: monitor, during a monitoring period, a movement of a vehicle; wherein the vehicle differs from the other vehicle; attempt to predict a future behavior of the vehicle based on a combination of at least two elements out of (a) light signals generated by the other vehicle during the monitoring period, (b) vehicle velocities and accelerations during the monitoring periods, and (c) spatial relationship between the vehicle and traffic lane during the monitoring period (d) an environment of the vehicles during the monitoring period; estimating an estimated impact of the vehicle on a future propagation of the other vehicle; and perform a driving related operation of the other vehicle based on the estimated impact.

There may be provided a computer program product that may store instructions that once executed by a computerized system that is positioned inside a vehicle, causes the computerized system to: receive, from at least one entity outside the vehicle, a request to change a mode of operation of the vehicle from a non-autonomous driving mode to an autonomous driving mode; determine whether to change the mode of operation; and when determining to change the mode of operation then change the mode of operation of the vehicle from the non-autonomous driving mode to the autonomous driving mode.

There may be provided a computerized system that is installed in an other vehicle, wherein the computerized system may include a processor and one or more sensors; wherein the one or more sensors are configured to monitor a movement of a vehicle; wherein the vehicle differs from the other vehicle; wherein the processor is configured to: estimate, based on the movement of the vehicle and a model of the vehicle, an estimated interaction between the driver and the vehicle; determine a status of the driver based on the estimated interaction; estimate an estimated impact of the vehicle on a future propagation of the other vehicle; and assist in performing a driving related operation of the other vehicle based on the estimated impact.

There may be provided a computerized system that is installed in an other vehicle, wherein the computerized system may include a processor and one or more sensors; wherein the one or more sensors are configured to monitor a dynamic behavior of a vehicle; wherein the vehicle differs from the other vehicle; wherein the processor is configured to: perceive a dynamic behavior of the vehicle; estimate a state of the vehicle; estimate an interaction between the vehicle and the other vehicle, and based on the estimated state and the estimated interaction, assist in performing a driving related operation of the other vehicle

There may be provided a computerized system that is installed in an other vehicle, wherein the computerized system may include a processor and one or more sensors; wherein the one or more sensors are configured to monitor, during a monitoring period, a movement of a vehicle; wherein the vehicle differs from the other vehicle; wherein the processor is configured to: attempt to predict a future behavior of the vehicle based on a combination of at least two elements out of (a) light signals generated by the other vehicle during the monitoring period, (b) vehicle velocities and accelerations during the monitoring periods, and (c) spatial relationship between the vehicle and traffic lane during the monitoring period (d) an environment of the vehicles during the monitoring period; estimate an estimated impact of the vehicle on a future propagation of the other vehicle; and assist in performing a driving related operation of the other vehicle based on the estimated impact.

There may be provided a computerized system that is installed in a vehicle, wherein the computerized system may include a processor and a communication unit; wherein the communication unit is configured to receive, from at least one entity outside the vehicle, a request to change a mode of operation of the vehicle from a non-autonomous driving mode to an autonomous driving mode; wherein the processor is configured to determine whether to change the mode of operation; and when determining to change the mode of operation then change the mode of operation of the vehicle from the non-autonomous driving mode to the autonomous driving mode.

### BRIEF DESCRIPTION OF THE DRAWINGS

In order to understand the invention and to see how it may be carried out in practice, a preferred embodiment will now be described, by way of non-limiting example only, with reference to the accompanying drawings:

FIG. 1 illustrates an example of vehicles and their environment;

FIG. 2 illustrates an example of vehicles and a computerized system;

FIG. 3 illustrates an example of a vehicle and a computerized system;

FIG. 4 illustrates an example of points of interest and an environment of a vehicle;

FIG. 5 illustrates an example of points of interest and an environment of a vehicle;

FIG. 6 illustrates an example of points of interest and an environment of a vehicle;

FIG. 7 illustrates an example of points of interest and an environment of a vehicle;

FIG. 8 illustrates an example of points of interest and an environment of a vehicle;

FIG. 9 illustrates an example of points of interest and an environment of a vehicle;

FIG. 10 illustrates an example of a registration process;

FIG. 11 illustrates an example of vehicles and a computerized system;

FIG. 12 illustrates an example of a method;

FIG. 13 illustrates an example of a method;

FIG. 14 illustrates an example of a method;

FIG. 15 illustrates an example of a method;

FIG. 16 illustrates an example of vehicles and their environment;

FIG. 17 illustrates an example of vehicles and their environment;

FIG. 18 illustrates an example of a method;

FIG. 19 illustrates an example of a method;

FIG. 20 illustrates an example of a method;

FIG. 21 illustrates an example of a method; and

FIG. 22 illustrates an example of vehicles and their environment.

### DETAILED DESCRIPTION OF THE DRAWINGS

Any reference to a system should be applied, mutatis mutandis to a method that is executed by a system and/or to a computer program product that stores instructions that once executed by the system will cause the system to execute the method.

Any reference to method should be applied, mutatis mutandis to a system that is configured to execute the method and/or to a computer program product that stores instructions that once executed by the system will cause the system to execute the method.

Any reference to a computer program product should be applied, mutatis mutandis to a method that is executed by a system and/or a system that is configured to execute the instructions stored in the non-transitory computer readable medium.

Any reference to a communication channel or a communication unit may include any type of communication link and/or channels such as wireless or wired, direct link or indirect link, cellular communication, satellite communication, Wi-Fi communication, and the like.

Any reference to a computerized system refers to one or more computers that includes at least one hardware processor, hardware memory unit and the like.

The term “and/or” is additionally or alternatively.

The terms “self-driving” and “autonomous” are used in an interchangeable manner.

A dynamic object may be any object that is not static. An object may be regarded as dynamic when is moves, when it is expected to move within a short period of time (for example a vehicle that temporarily stopped in front of a cross road), and the like. Non-limiting examples of a dynamic object may be a vehicle, a person, objects that temporarily move (for example—trees that are moved by the wind), and the like.

A driving related operation of any vehicle can involve multiple units/components of the vehicle. Each unit/components may assist in the execution of the driving related parameters in various manners including but not limited to instructing, triggering and/or requesting another unit or component to perform an action or to prevent from preforming an action. The assisting may also include performing the action or avoiding from performing the action. The unit/components may or may not belong to a computerized system that is installed inside or outside the vehicle.

A dynamic database is a database that may store information about expected behaviors of dynamic objects (for example—expected acceleration of a vehicle of a certain model and at a certain junction). The information may include statistics related to previously monitored behaviors. The dynamic database may be maintained by a computerized system that is located outside a vehicle.

The dynamic database may also include information about changes in environmental conditions.

The statistics may or may not be time sensitive. The statistics may be provided per at least one of the following (or per a combination of at least two, three, four, five, six or more of the following): time window, location, direction of propagation, similar locations, prototype locations, dynamic object, model of vehicle, driver, road, lane, road segment, type of vehicle, per junction, traffic light, building, risk level, velocity, weather condition, and the like.

For example, the statistics may be indicative of at least one out of:
a. Time sensitive distribution of vehicle types in a lane.
b. A behavior of dynamic objects within one or more junctions.
c. A relationship between a state of one or more traffic lights positioned in one or more junctions and a behavior of dynamic objects within the one or more junctions.
d. Speeds at different direction within one or more junctions.
e. Different types of vehicles within one or more junctions.
f. Behaviors of different types of vehicles and one or more people within one or more junction.
g. Behaviors of dynamic objects selected out of vehicles and people in a vicinity of one or more building.

Non-limiting examples of information that may be stored in a dynamic database or in another database and sued in association with information stored in the dynamic data base may include, for example the following:

Behavior of cars (as a function of road type condition and lane marks.) For example:

a. Trucks tend to slow down at this location.
b. Cars slow down near an accident (maybe there is something interesting to see).
c. Car sometimes turn left even though there is no legal turn.
d. Motorcycles tend to ignore the white line.
e. Police car at this location tend to cause a slowdown in traffic.
f. PepsiCo (or Coca Cola) cars slow down (next to the delivery location)

Behavior of cars (as a function of the driver)

a. Young men tend to speed up
b. Young men (here) ignore the stop sign 10%
c. Women turn left 45%
d. Military turn left 78%

Behavior of cars (as a function of time of day)

a. During school starting time many drivers tend to do double parking.
b. On Sundays drivers tend to turn left at this location to church.

Behavior of pedestrians

a. According to time of day, depending on young, adult, male, female, groups.
b. According to what they do (looking at phone, playing). Not talking on the generic information (person looking at phone does not see what is around him), but on the specific location information, in this place kids jump into the road more than others.

Common behavior given a combination of pedestrian and cars, for example:

a. Next to a school, a car parking on the other side of the road, increase the likelihood of a kid jumping to road running towards the car. This is not true for every location and at any time, but only under specific combination.

Animals or pets and their behavior

a. Dogs get spooked here and jump to road
b. Pets tend to run on the road near the Dog Park.
c. Deer crossing

Temporary road Condition Warnings:

a. Falling Rocks warning.
b. Scrubbed road.
c. narrow shoulders.

Glare and Lightning condition:

a. Glare at sunset at a certain road direction and specific hour
b. Glare from a building window during sunrise or sunset.
c. Glare from flashlights on a wet road during nighttime.

Wind conditions:

a. Strong wind
b. Related to forecast but for specific road location. Place where side wind is expected. This impact expectation of car but also expectations from other cars.

Road and surface conditions:

a. This location sometimes has oil on the road.
b. This road is likely to be frozen if (weather condition, or information from other stretch of roads in the area).

Patterns of lights, of road signs

a. Road signs and billboards can impact driver's behavior. General if a sex related road sign, man slow down, specific for the movie shown here the reaction at this part of it is . . .
b. Red light last 20 seconds.
c. Street light start at 20:00 on weekdays.

Lanes:

a. Distribution of car types in lane (public transportation/expensive/cheap cars).
b. Distribution of speed in lane as a function of time of day. (can be useful for choosing lanes)
i. For example, on which lane it is preferable to be approaching a light
c. Information regarding parking on lane as a function of time of day, or day of week.
d. Information regarding public transportation (public transportation only, bus stop).

Junctions:

a. Distribution of speed at a junction in each direction, as a function of time of day. (same as in lane)
b. Behavior of cars at a junction, as a function of car type and time of day (e.g. Lamborghini is more likely to speed in yellow light than Fiat).

Buildings' Metadata:

a. Type of building (kindergarten, elementary school, high school, police station, parking lot, store, construction site, etc.).
b. Distribution of vehicles around building (e.g. more cyclists near high school, more trucks around construction site).
c. Distribution of pedestrians around building (e.g., more children around school).
d. Behavior of vehicles around building (e.g. slowing down near parking lot).

Vehicles' Metadata:

a. Acceleration ability and Max Speed of each car type:
i.e.g. Lamborghini can accelerate much faster than Fiat.

Information about static objects, navigation information, points of interest, and/or any other type of information that may affect a driving of the vehicle may be maintained in another database—or may be stored in any manner in the computerized system.

There is provided a dynamic database (also referred to dynamic database or DDB) and various cars that work together.

A DDB can send a request to the car asking for information it needs. There may be various types of information that the DDB can request and how it can request it. Furthermore, in some cases, the DDB can send a request to the car to move in such a way as to collect the desired information.

The DDB may be supplemental to that used for navigation. A static dynamic database may include information related to static objects only. One usage is to add mapping information about dynamic items that are not in the static dynamic database. Those include statistics on behavior (e.g., kids running into roads), this is not part of the static database, but information learned about the place.

The DDB may also include suggested actions—given an obstacle (that might appear also in the static dynamic database), there is a suggestion of how to pass it. The suggestion of how to navigate and pass it, as well as the temporary hazard themselves will be part of the DDB. The suggestion may depend on the car, different cars, and different driver preferences will receive different suggestions as a function of their speed and location.

The DDB may differ from the static dynamic database as it is not only about the static objects.

For this DDB we need all sort of information sources, mainly car and people, but also the internet, and many others. This is mainly useful for self-driving cars, giving them the right context.

Mapping is helped by having objects in the DDB that make it easy for the car to self-locate itself. Even if those objects are not needed for other navigation tasks.

Mapping to predict behavior of dynamic objects and conditions

Dynamic maps will be used to predict the future behavior of objects which are not part of the static maps, but are relevant for driving.

This can help in the process of predicting the possible position of a car in the next time frame. Some car can turn at higher speed so while we may not expect one type to turn another may be more likely to do it.

The examples are for dynamic properties of the location. In this section we are not talking about temporary properties for which other solutions, such as car to car communication are used. Temporary property may include specific road hazards (stone on road, oil) or other things that are not permanent property of the location, such as a parked car, but happen to be there.

In order to use such dynamic information, we introduce the following process:
a. Collect information.
b. Calculate statistics.
c. Store the information efficiently in a DDB.
d. Retrieve this information to moving cars
e. Use the information to improve driving.

Collect information

The information is gathered over time using the autonomous car sensors and other sensor(s). For example, each autonomous car will record the behavior of the vehicles around it and may send this information to a central database. It may record any of the information described above and send to the DDB. Sensors may be stationary sensors in the location sensor on vehicles or any sensors that are willing to report to the DDB. Another source of information is the car self-reporting: If we know the travel plan of the car, we know, for example, if it turned left at a junction and can use it for our statistics. We may also know the car's velocity during the trip and other more refined information (collected for statistics of maps). Furthermore, in the near future, people will be walking around with cameras on them at all time (due to augmented reality applications). They can be used as dynamic sensors, sending data to many data bases for processing, some data from people will also be collected (e.g. their speed and behavior at different locations).

The data may be sent as raw data, or as event data. If sent as raw data, what the sensor sees or some slight processing on it, the DDB will take the events of the data. If sent as event, the calculation is done locally (or in another DB) and sent to the DDB as event. Any combination is of course possible. The DDB can also ask the sensors for data, in which case they may sent raw data, or events upon request.

The information may be collected from the internet (for example, stag migration, weather, school start late today), the information may be collected from traffic control (the light schedule). The information needs to get to the DDB so active collection is needed. Some of those data point, currently, are not sent from the car to the DDB. For example, if a car passes the white line, currently, the car passing and the one observing may not share it with the DB.

There are multiple reasons why the car does not share everything with the DB. The first is technical, sharing all its sensor's information will put a huge communication burden, currently not possible with our technology. The second is that it may violates all sort of privacy issues (for example tracking people).

We may be interested in specific events (car passing line, car turning left, etc.). We can ask our sensors or carto report only those kind of events, or at least those events it is smart enough to recognize. It is likely that any events the car can use for driving, it also knows how to recognize, so we assume it is most of the event (An autonomous car will probably be able to recognize those type of events for its cognition and navigation ability).

The car is informed of the DDB's need of information and send the DDB discreet events (not sensor information to analyze). Such type of discrete event might look like—“truck on location X going direction Y around time T (can be random within five minutes to maintain anonymity), passed the white lane by 50 cm going around 80 KM/hour. Sending such high-level events, even if thousands per hour, or even millions, require very limited broadband which is negligible for the car. Furthermore, to avoid privacy issues we can add a random dT (up to 5 minutes) to the timestamp of the reported event and assure anonymity of the reporter.

Calculate statistics

Calculating the statistics can be done in multiple ways—some of which are illustrated below.

The simple approach is to take the data collected from the first phase, for each location, and using it. The problem with such approach is that the raw data is sparse, and we will not have the same amount of information for each location. For example, the percentage of cars with male drivers passing the white line may be based on very small sample.

The second approach is to create prototype locations. Couple of examples of prototype locations: a stretch of a two lanes highway, a stretch of a three lanes highway with a divide, or four way stop intersection, or a four way stop intersection where one way is much busier, A one-way street next to an elementary school etc. Every location on the map corresponds to some prototype location that best describes it. In this approach, statistics are merged using the information we collected on the specific location and the common statistics related to the prototype. When using this approach, we prefer to report to the user the per-location statistics, but if we didn't collect enough data we can report the porotype location statistics.

A third approach is to create a similarity function between locations. Each location on the map is unique, but information from other similar places is usually also relevant, the more similar they are the more relevant. Locations might be more similar to others with respect to some given parameters, which can be learned by the learning algorithms. For example: a scenario where a pedestrian is crossing the road next to a school. The important parameter may be the age of pedestrian in order to predict his behavior. Another example of a car passing the white line on a curved road, here the leading parameters might be the road curvature, the car speed, or road visibility. In this approach, the most influencing features will be learned from the data. The similarity between locations according to their parameters is studied and then used to estimate cars or pedestrian behavior for locations where our data is sparse. As the similarity between locations depend on the parameters we want to estimate, it is quite likely that different features will be enhanced from each location.

When we divide the world into prototype locations, the more locations we have the better the fit to arbitrary locations. Better fit will also mean better performance. But, more prototype locations we have, the less location will match each prototype, meaning less data sharing between locations. There is a clear tradeoff between the amount of porotype locations and their descriptive ability of the prototype. On one end, we can use a single prototype to describe all four lanes highway stretches. On the other end we could describe a prototype location as a four-lane highway stretch, at elevation 500-540 feet, heading north between 139-147 degrees, with borders or 1.5-17 yards without separator, and 2-2.3 yards between the opposing lanes. Having a more descriptive prototype location is very useful in predicting behavior based on other places, it is also useful in compression of information. But it will render the number of places we can compare to, small.

If we don't divide the world into prototype locations, we can still calculate location similarity using machine learning. Once we have that, we know which information learned in similar location is likely to be relevant.

The basic algorithm for finding the correct values for the different properties may include the following steps:

Step 1—Calculate the values of the properties for the locations using direct observation for that specific locations

Step 2—Given the value of the properties calculated in 1, the physical properties of the place, and any additional information about it, calculate similarity function to other places. The similarity may be in general or per property. In general means location A and B are similar and something we learned on A is relevant to B. Property specific means that if location A and B are similar on some properties, then we can learn from A to B on some properties.

Step 3—For every property calculate a value using weighted average of the values calculated in step 1 and the values of similar locations.

A second possible algorithm can be

Step 1—Calculate the values of the properties for the location using direct observation for that specific locations

Step 2—classify the location into prototype locations (i.e. rural road next to school)

Step 3—Given the value of the properties calculated in 1, the classification to a prototype location of step 2, use weighted average of the values measure and those in the same prototypical locations.

Storing information efficiently in a DB

We want to store information for each location, and later on send that information to the car. We present a couple of approaches for efficiently saving the information in the DB.

We can store information on each location by itself to the DB this is a very simple approach but may lead to large footprint in storage. Notice that we are not storing the whole map, but only properties extracted from it, so we have an order of magnitude less than saving the whole accurate map, but still very large.

If we use the prototype locations approach, then each location is stored as the prototype location+the diff of the specific location from the prototype. This can be fairly efficient both for storing and for transmitting to the car (who may have the prototype locations statistics in its own DB).

An intermediate approach is to use the prototype locations only in the DB, in order to make it more efficient. For every location we will store the prototype location index+diff for the current location. When a car makes a request for information regarding a specific location we will send her the specific location statistics, so basically the car does not know about the prototype locations approach.

Generally speaking, our DB holds an entry per location. We define location as a geographical area of some size such that all points inside that area have similar properties. So basically, the larger the locations' areas are, the less storage we need to store all locations information, as well as less communication with cars. But using large area for each location may cause accuracy reduction. For example, considering a stretch of highway that is 10 km long. We can take the whole stretch and relate to it as a single location with a single set of properties. On the other hand, we can divide the stretch into 10 or even 100 small parts of the road, and save each part as a different location with its own set of properties. In this case some of the properties (e.g. average speed of cars) will probably be very similar through all the location, and other properties may vary (e.g. density of trees along the way).

The parameters could be very similar for a stretch the length of KM, but will be more accurate for smaller stretch. It is unlikely that parameters such as probability of passing and speed are totally uniform. If they are—we can make it one location. If the difference is insignificant than one location. If the difference is important to the car driving than we need to split the location. Splitting location has impact on storage size of the DB and on accuracy and on communication bandwidth between DDB and cars.

Retrieve this information to moving cars

According to the storing paradigm used (see previous section), whenever a car arrives to a known location it can query the DDB to get the dynamic information related to it. It is also possible that the DDB will be pushing this information. Using this approach, the DDB will send information to the cars, based on filters of the car, when it is agreed that the information is of interest.

If the car stores the prototype locations statistics information, then the DDB can send only index of the prototype location and the delta between the prototype and the current location. The delta footprint is small so the whole communication process is very fast and efficient. As the DDB may be aware of the car driving algorithm, it need to send only information that will make a difference to it. It can calculate when the information sent is different than the defaults and will make a difference. This is expected to be very small amount of data.

Information usage to improve driving

This database will contain, among others, the behavior of many cars in many locations and will use this data to predict the behavior of moving objects (cars, pedestrians, animals, etc.) in a new event. This analysis will consider the location and as well the type of scene (junction, also type of the junction, one-lane road, multi-lane road, connection to the highway, etc.).

For each junction location on the road we will know for each car type (e.g. private, track, or even a car model—BMW Mazda) how the car will accelerate on a green light (or behave when the light is change to red) This might be change in different junctions and in different countries (Italy vs US). The behavior of the children next to the e school will be deepened on the hour, What school (junior, high school: e.g. on high school they will have electric bikes) using deep leering we can find it automatically and use this info for driving decisions

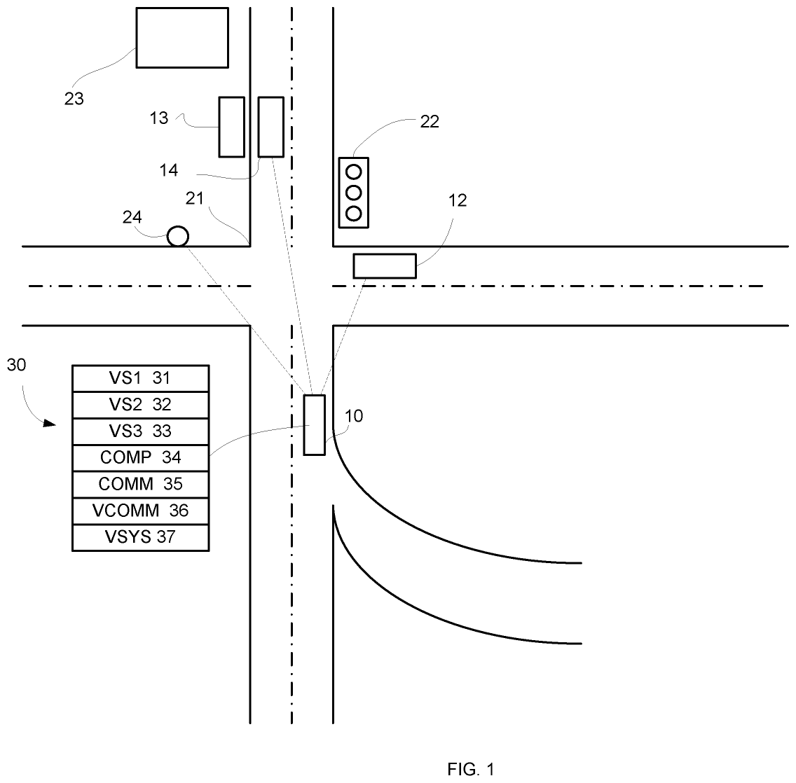

FIG. 1 illustrates an autonomous vehicle 11 that approaches a junction 21.

Vehicle 11 may include units/components such as three sensors (or three types of sensors) VS1 31, VS2 32, VS3 33, a computer 34 that may execute any of the methods related to a vehicle in the specification, a communication unit 35 that may communicate with entities outside the vehicle, a vehicle communication unit 36 that may communicate with units/systems of the vehicle such as vehicle systems 37 that may include an engine, an engine controller, a gear unit, an air conditioning unit, brakes, a multimedia unit, and the like.

Computer 34 and zero or more other components/units mentioned above may form a computerized system 30 that is installed in the vehicle.

An autonomous car drives on a street and approaches the junction 21. The system of the autonomous car 10 detects a blue Mercedes car 12 that is about to cross the junction in the other direction and pinpoints its location. The systems check what is the predicted behavior of the car type Mercedes at the specific location at the specific time of day. The query is analyzed based on past events in that area considering the time of day, the location and nearby buildings. A prediction of the car's future behavior (speed, acceleration etc.) is made (e.g. the Mercedes will accelerate and cross the junction at yellow light). The data is used in the autonomous car to take its own driving decisions (e.g. slow down and let the Mercedes cross the junction safely).

The autonomous car 10 may notice another car 14 double parking (parallel to parking car 13) on the other side of the street. Usually it is not a concern. However, if the location is near a school 23, we get a warning that this might mean that a kid will want to cross the street to get into that car, coming from our direction. No warning will be displayed after school hours Similar warnings can occur whenever we pass next to a place in which kids are collected, like swimming pool, game areas, cinema, and may depend on the age of the kids involved. Of course, such warning is not only limited to kids.

Database and storage

The following section describes two ways of implementation which dictate how the database will be built and how it will work:

Per-Object Metadata—The database will include extra metadata on interesting locations and points on the map. The extra metadata will be used in the driving decisions process.

Per-Point Metadata—The database will contain all available information per location and let Deep Learning deal with finding the logic in it. The idea is to mark a grid of points on the road and track the behavior of cars passing each point.

Per-Object Metadata

Our database will include extra metadata on interesting locations and points on the map. The extra metadata will be used in the driving decisions process.

Keep in mind that this Metadata is ‘static’ and is not updated every second, thus it contains only roughly permanent information. It cannot contain information on obstacles on the road, for example, since these tend to appear and disappear frequently.

The metadata will be stored per object and its location, thus making the searching and pulling data from the table fast and efficient.

Examples of Metadata that will be stored per object:

Lanes' Metadata:

a. Distribution of car types in lane (public transportation/expensive/cheap cars).
b. Distribution of speed in lane as a function of time of day.
c. Information regarding parking on lane as a function of time of day, or day of week.
d. Information regarding public transportation (public transportation only, bus stop).

Junctions' Metadata:

a. Constant basic rules of junction (no U-turn allowed, pedestrian crossing on right turn).
b. Distribution of speed on junction in each direction, as a function of time of day.
c. Behavior of cars in junction, as a function of car type and time of day (e.g. Lamborghini is more likely to speed in yellow light than Fiat).

Buildings' Metadata:

a. Type of building (kindergarten, elementary school, high school, police station, parking lot, store, construction site, etc.).
b. Distribution of vehicles around building (e.g. more cyclists near high school, more trucks around construction site).
c. Distribution of pedestrians around building (e.g., more children around school).
d. Behavior of vehicles around building (e.g. slowing down near parking lot).

Vehicles' Metadata:

a. Distribution of car types in each area (city, state).
b. Distribution of driving speed of each car type in different scenarios (e.g. Lamborghini is likely to have higher average speed on highways than Fiat).
c. Acceleration ability and Max Speed of each car (e.g. Lamborghini can accelerate much faster than Fiat). This can help in the process of predicting the position of a car in the next frame.

Per-Point Metadata

Another way of storing Metadata on the map is to save all available information per location, and let Deep Learning deal with finding the logic in it. The idea is to mark a grid of points on the road and track the behavior of cars passing each point.

In this method, our prediction algorithm is not based on analyzing the car's behavior and understanding the logic behind the behavior. Instead, we let Deep Learning analyze the training examples, where each training example is an event of a car passing some point on the road at some speed and acceleration. The trained Neural Network will embed the behavior of cars in different areas in different scenarios. Finally, given a testing example of a car that is about to pass some point on the road, the Neural Network will predict its speed and acceleration.

Training

The training of the network may be based on thousands of training examples. Each training example includes the details about an event of a car passing a specific point at some point in time and in some speed and acceleration. The training vector shall include the following information:

a. car type
b. coordinates' position of the car
c. time of day
d. heading direction.

The Neural Network will be trained to receive the input vector and predict the speed and the acceleration as the output of the net.

The Neural Network will eventually learn the logic of the driving in each point. For example, if some POI is close to a school, most cars will slow down at that area. Another example, a Mercedes is more likely to accelerate faster after a crossroad than a Fiat. The Neural Network will learn these behaviors of cars, and when a new car will approach this point, it will predict its speed and acceleration in that POI.

The Neural Network will be trained offline based on the training examples that are reported to the cloud.

Testing

The testing of the Neural Network will happen in real time when the system wants to predict the behavior of a specific car in some position. The system will send a query to the cloud including the car type/model, the position of the car and the time of day.

The Neural Network will use the given example and predict the speed and acceleration of the car. The prediction is sent back to the requesting car and used for its driving decisions.

Shrinking Data Storage

Storing a Full Neural Network for each point can be significantly storage consuming. However, we understand that it is likely that close points on the road will have similar Neural Networks. We propose a method for merging similar Networks, if their learning weights are similar enough.

How to update the Metadata map?

The Metadata in the map will be updated in two main manners:

Self-statistics—An autonomous car which is connected to the cloud will send its own metadata and statistics about driving speed, acceleration.

Scene statistics—An autonomous car detects and measures information about other vehicles and pedestrians during the driving process. This information will be sent to the cloud as reports about a specific car, at some location, driving at some speed, etc.

External updates—information from other sources than the autonomous car system. For example: update from city municipality regarding public transportation or closing of roads for construction.

Acceleration of my car and other cars

Mapping to predict static obstacles and road conditions

The system will be able to control the vehicle's speed, or suggest speed, to go over obstacles and road humps smoothly. The sensor will measure the 3D structure and based on this structure it will set the vehicle's direction and velocity which will be based on the vehicle's suspension system and other vehicle characteristics.

BUMPS

For each vehicle, we can prepare a table what would be the optimal speed to go based on experimental data for different road humps. The parameters' space we should check can as in the following table or others. A table based on this parameter space will be created as described in the following experimental data table example:

| | | | | Other: | | |
|---|---|---|---|---|---|---|
| Max | | Entering | | color, | | Optical |
| height | Length | angle | | pattern, | Approaching | speed |
| (cm) | (cm) | (deg) | Material | shape, etc. | method | (km/h) |
| 5 | 200 | 15 | Concrete | None | Both wheels | 30 |
| | | | | | together | |
| 10 | 200 | 15 | Concrete | Non | Both wheels | 25 |
| | | | | | together | |
| 15 | 200 | 15 | Concrete | Non | Both wheels | 20 |
| | | | | | together | |
| 20 | 200 | 15 | Concrete | Non | Both wheels | 15 |
| | | | | | together | |
| 25 | 50 | 15 | Plastic | Non | Wheel by wheel | 10 |
| 25 | 60 | 15 | Plastic | Non | Wheel by wheel | 10 |
| 25 | 70 | 15 | Plastic | Non | Wheel by wheel | 10 |
| 25 | 80 | 15 | Plastic | Non | Wheel by wheel | 15 |
| 25 | 90 | 15 | Plastic | Non | Wheel by wheel | 15 |
| 25 | 100 | 15 | Plastic | Non | Wheel by wheel | 15 |

When the vehicle is approaching the road hump, the system calculates the 3D structure of the road hump and finds its characteristics. Based on this, it finds in the table which road hump resemble it the most (its parameters and 3D shape is the closest to it). Then based on the table, the optimal speed and approaching method will be selected.

Additionally, in the translation table there will be also known road humps with specific standards which can be identified also using other characteristics such as color, pattern, shape etc. In cases where the system identifies a known road hump, it will use its specifications.

The road humps will be dynamically mapped, so in cases where we know our GPS location, we can know which specific road hump we are approaching and its characteristics. In these cases, the system will still verify that there was no change in it and report it to the dynamic database.

As is clear from the above sometime the vehicle sensors are used to understand the road hump. There are two problems, the first is that it requires lots of calculation and the second is that inherently unlikely that the car sensors will be able to map the entire hump/obstacle as some of it is hidden, the hidden part, may be important.

We also have the solution that the hump is part of the mapping DB. The DB probably does not include a description of the hump (this is not needed) but direction on how to pass it. The direction will include speed and approach type for different vehicle classes.

The learning will be done by seeing how previous vehicle did when passing. Seeing which approach and speed they have used and how the car was impacted by the hump, using the car or phone accelerator or other sensors. Generally, it is likely to be advantageous to check how locals treat the hump as they have gathered knowledge. So, the correct approach may be that of locals with similar vehicle.

The hump may be a permanent fixture, but the description is applicable to any obstruction, some more temporary in nature. Oil on the road is another example, in which the map learns of the hazard and convey the information, as best it can, to the approaching cars.

The DB may ask the car to approach the hazard in a specific way, also to learn about the hazard.

Interactions between the data base and sensors.

In the case that the car gives information the DDB—there may be payment involved, especially if the car did some change in its driving. Need to be mentioned the option.

The DDR can be stored in the cloud or in another central database (a version of it or a part of it can be kept in the car). The DDB will communicate with many cars: it will send messages to them and it will receive messages back from them. It will hold the information acquired from many cars. Additionally, it will have access to additional information, such as weather, road construction information, traffic information, new road introduction GUI, etc.

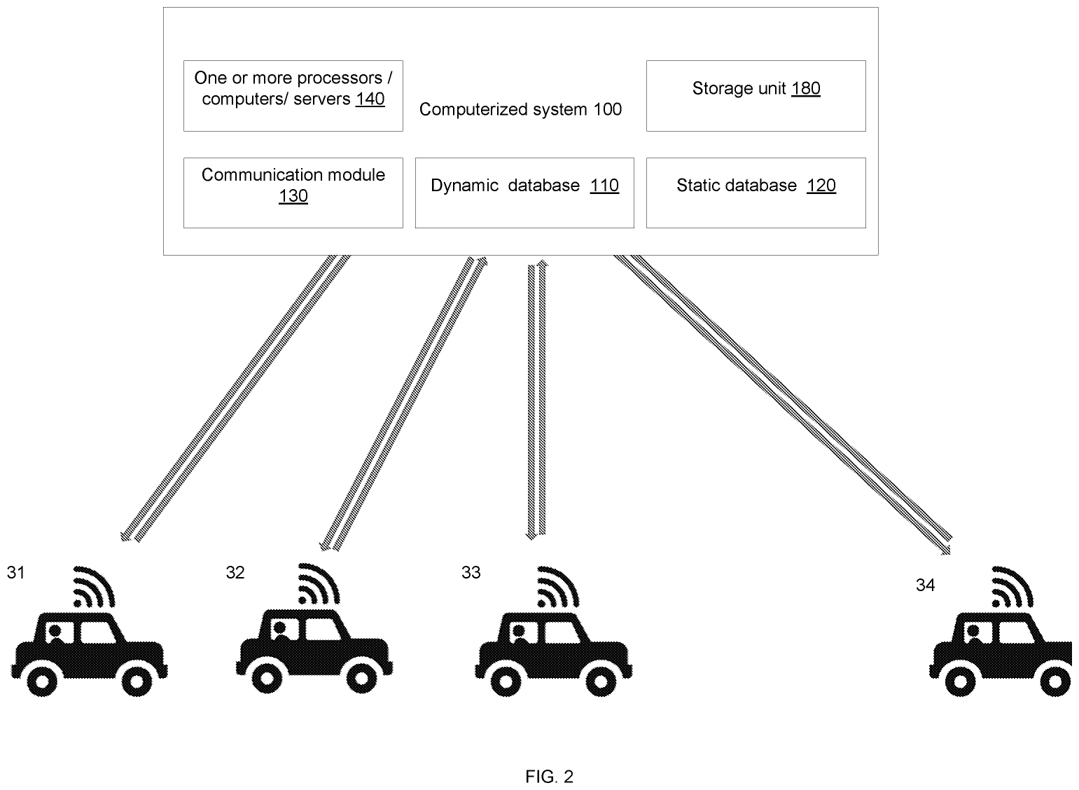

FIG. 2 The communication of the car and the map database will be in both ways.

There may be bi-directional communication links between computerized system 100 and vehicles 31, 32, 33 and 34. The computerized system may include a communication module 130, a dynamic database 110, static database and one or more processors/computers or servers 140 and storage unit 180.

The car will get part of the database based on the car's location (e.g. we might want to have all the time a map of 100 km around the car) or access updates and changes in the central database (e.g. 1. there is road construction and database was changed, 2. the POI was changed). Additionally, the DDB can ask the car to send it data based on different criteria.

The car itself will send to the DDB data based on request of the DDB or data as result of new discoveries it met on the road. Furthermore, the DDB can ask the car to send it data based on some other criteria.

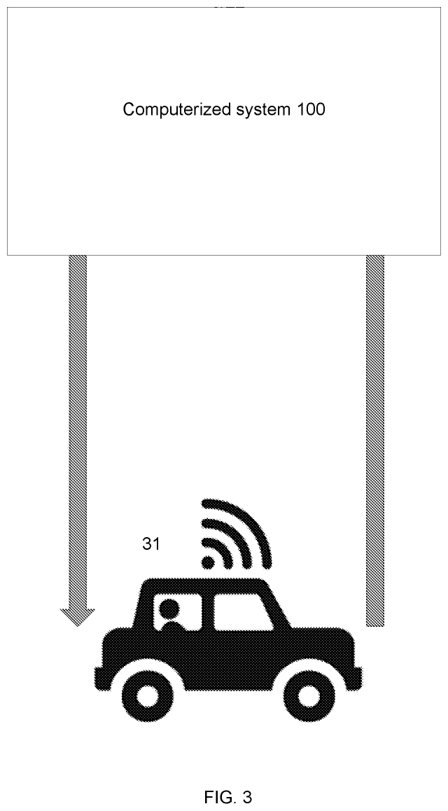

FIG. 3 illustrates a computerized system 100 that communicates with vehicle 31.

Message from DDB to Car

Update database—send the part of the data base that is relevant to the car. This happened in deferent cases for example

Change in the car location

Change in the database

Request for information. Need to update. In case the database need more information based on car reports or external reports

Uncover region (for example an introduction of new road to the database)

Fall/new traffic sign/light

Region update

Update Road construction.

Update POI

Report a behavior of moving object

Message from Car to DDB

Report of mismatching database and car sensors data. E.g.

Fall/new traffic sign/light

Region update

Update Road construction

Update POI

Report a behavior of moving object

Request for map info database based on my location (in case that the car is at the end of its map)

Answer for Request for information. Need to update. Send the information of the scene. E.g.

a. Fall/new traffic sign/light
b. Region update
c. Update Road construction
d. Update POI

Report a behavior of moving object. E.g.

a. A car in a junction
b. Pedestrian in a location

This two-way communication can be described as: message from DDB to the car and message from the car to DDB.

Message from DDB to Car

Update database—Send part of the database that is relevant for the car. This can happen in different cases, for example:

Change in the car's location

Change in the database.

Request for information: Need to update. In case the database needs more information based on the car's reports or external reports:

Uncovered region (for example, introduction of new road to the database)

Fall/new traffic sign/light

Region update

Update road construction

Update POI

Report behavior of moving object.

Request for navigation change in the car so it can move to a different location for information gathering purpose

Message from Car to DDB

Report of mismatching database and car sensors' data. E.g.

Fall/new traffic sign/light

Region update

Update road construction

Update POI

Report behavior of moving object.

Request for map info database based on my location (in case the car is at the end of its map).

Answer for request for information. Need to update. Send the information of the scene. E.g.:

Fall/new traffic sign/light

Region update

Update road construction

Update POI.

Report behavior of moving object. E.g.:

A car in a junction

Pedestrian in a location.

An example can be when a stop sign falls, road constructions, etc. The flow in this case can be:

A car which was using the database finds that the Map Database is mismatching the measured 3D space that has been acquired by its sensors. The car is reporting this mismatching to the database.

As a result, the database is issuing an update request from few cars which are close by.

Those cars, when they arrive at the location, make measurements and take images of this location and send their data back to the database.

After gathering enough information, the database is updated.

This update is sent to all the cars.

The important thing for this part is the DDB asking the car for information. Currently there is a DDB it is having a two-way communication with the car. The car is sending the DDB obvious information it needs like places where the map was wrong. All this may be new but maybe not.

The part that is important is that DDB asking for the car for information, on a location, object or whatever. Information the car will not send by default. It could be something that is not on the road, or not relevant to the car, or just not sent normally, like color of road, or picture of tree. The DDB can ask for such information by telling the car what it needs, and the car may send the information to the DDB. This none standard situation is something we envision needed to implement such a DDB

Further, the DDB may need the car to move a bit to collect this information, it can be to move so that its sensors are better placed. It can also be moved so it checks hazards in specific ways. It may be taking another route (with little difference to the car) to help the DDB. Taking a different lane, etc. The ability of the DDB to have the car move differently so that it can collect data for it, is also an important part of the communication protocol (and maybe the payment protocol).

So, the DDB can ask the car for specific sensory information. It can ask the car to move differently to collect information for it. Those things are the main new additions for the communication between the DDB and the car.

Localization and Mapping

This section describes our method for localization and Mapping. One of the most fundamental problems for an autonomous vehicle is to keep track of its own position and localize itself inside a map. This process is called SLAM (Simultaneous localization and mapping) or Odometry.

During our discussion we will use multiple coordinates systems as part of our terminology. The first system is the GPS coordinate system where each point is measured as a triple (latitude, longitude, altitude) from the center of the earth. In this system each point on earth has a unique description. The second coordinate system we will be using is the Car's coordinate system were the origin is the starting position of the drive, and each point is measured as (x,y,z) in respect to the start point.

Map and POIs structure

Map structure

Storing a map of the driving environment is used for the process of localizing and pinpointing the exact location of the car in the environment. The process of storing the map in a database is a question of WHAT you save and HOW you save it.

A naïve approach is to ‘save everything’, meaning to save a full 3D map of voxels with the exact position and color of each voxel. Very inefficient, but you can then render an image of the area from any viewpoint. This is actually not required, since we can know the colors from the previous frame easily.

On the other hand, we can save information only about “points of interest” (POIs) and their location in the 3D map (or reduced 3D map). A POI can be a corner of a building, a center of a traffic sign, etc. By storing this information, we can eliminate “points of interest” search (e.g. SIFT) and save computing time. Also, by putting the POI in a central database, we can collect many POIs from many cars (and from many locations where the car was in the past) and we can evaluate how good each POI is. Then select dynamically the best POI for 3D mapping.

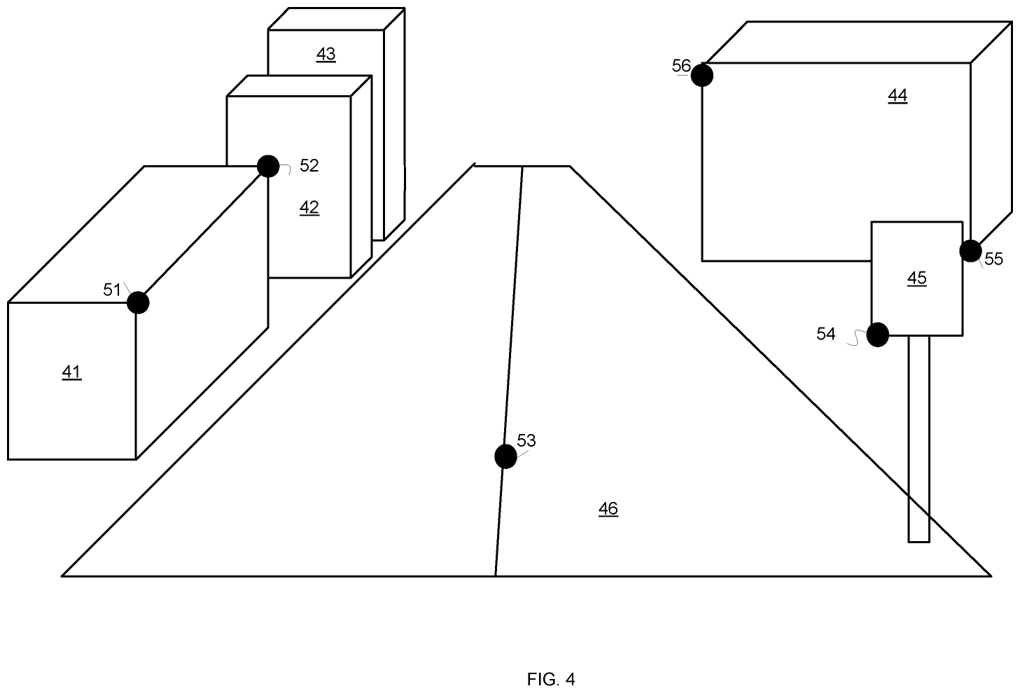

FIG. 4 illustrates an example of points of interest and an environment of a vehicle.

Points of interest 51, 52, 53, 54, 55 and 56 may be associated with distinguishable locations such as one or more corners of buildings 41 and 44, corners of traffic sign 45 and the middle of road 46. In FIG. 4 some buildings (42 and 43) are not allocated with points of interest.

Choosing the POIs

The main challenge is how to choose the POIs. On one hand, the POI shall be easy to find and to recognize in the image. On the other hand, the POI shall also be distinct by depth and be Lidar detectable.

Furthermore, we want any given scene to have ˜100 available POIs in the range of 100 m from the car. The POIs should be spread at all distance range and on full field of view. We assume that an average scene will have ˜100 available points and only half of them will be visible to the system at a specific point in time.

For example, the red point in the window might be easy to recognize by camera image, but Lidar will fail to shoot laser on that point due to glass reflectance. A better choice of POI should be the green point on the corner of the window. Another example is the red Stop sign, which is hard to recognize in an image due to the red background, but is rather easy to recognize using LIDAR point and shoot.

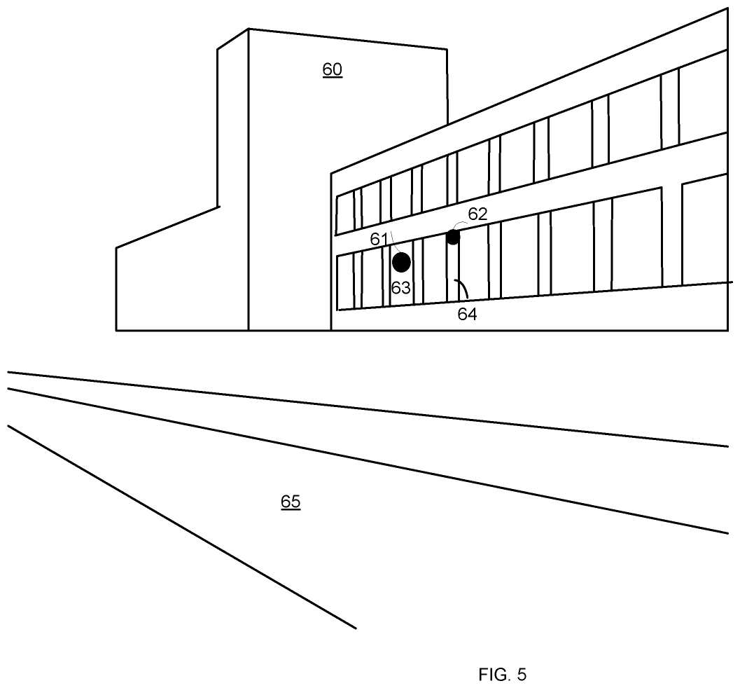

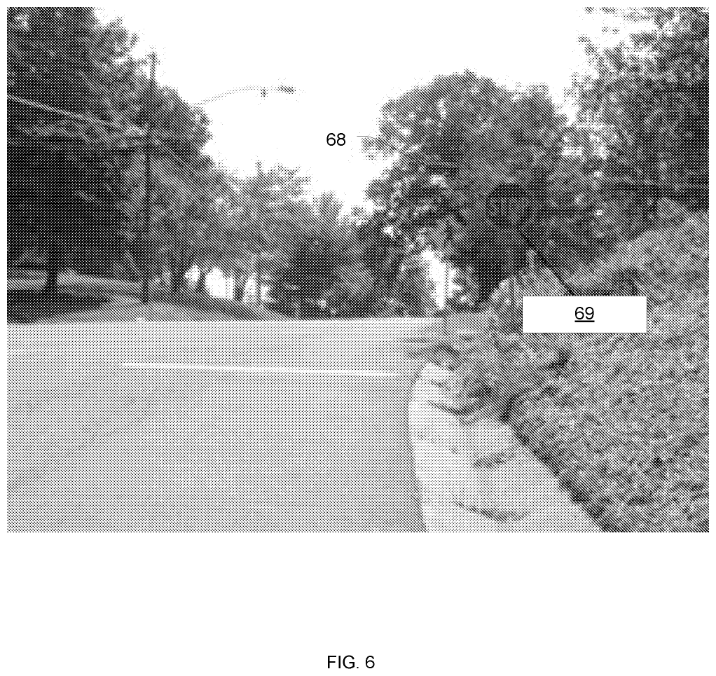

FIGS. 5 and 6 illustrate an example of points of interest and an environment of a vehicle.

In FIG. 5 a building is located to the left of the vehicle. A first POI 61 is located on a window 63 and a second POI 62 is located on a spacing 64 between windows. Under certain conditions is may be better to select the second POI.

Good points should be first of all static and also distinguishable both by depth and by color. Furthermore, it should be in a location where a small misalignment will not give a change in the distance as a result of measuring the background of the object. As result, a good POI (for example POI 69 of FIG. 6) will be for example a sign (e.g. Stop sign 68 of FIG. 6), where we should point to the center of the sign and not to the edge of it.

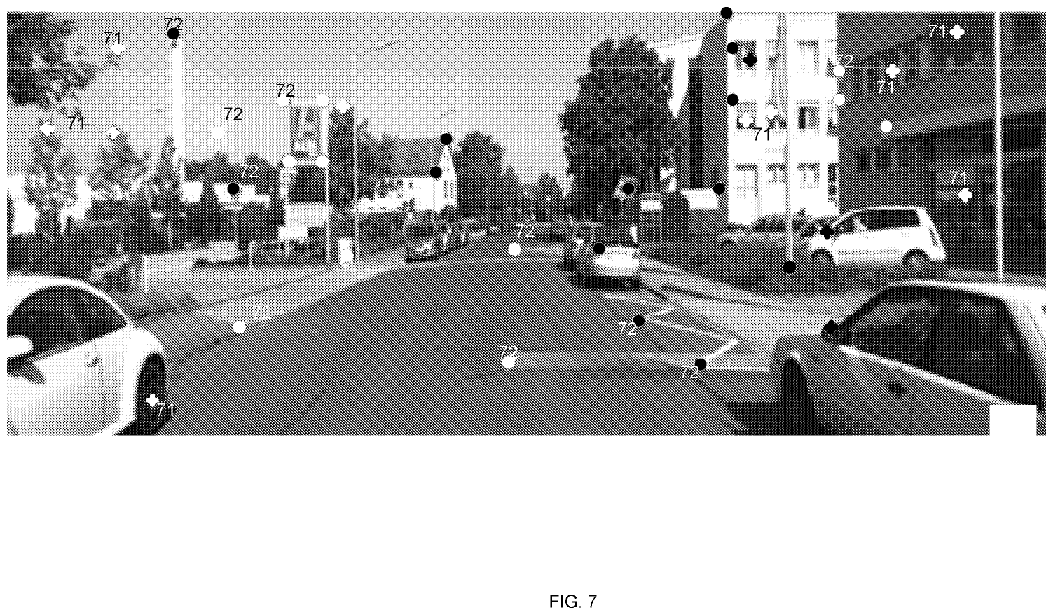

FIG. 7 displays a couple of good choices for POIs (denoted by circles 72) and some bad ones (denoted by +symbols 71).

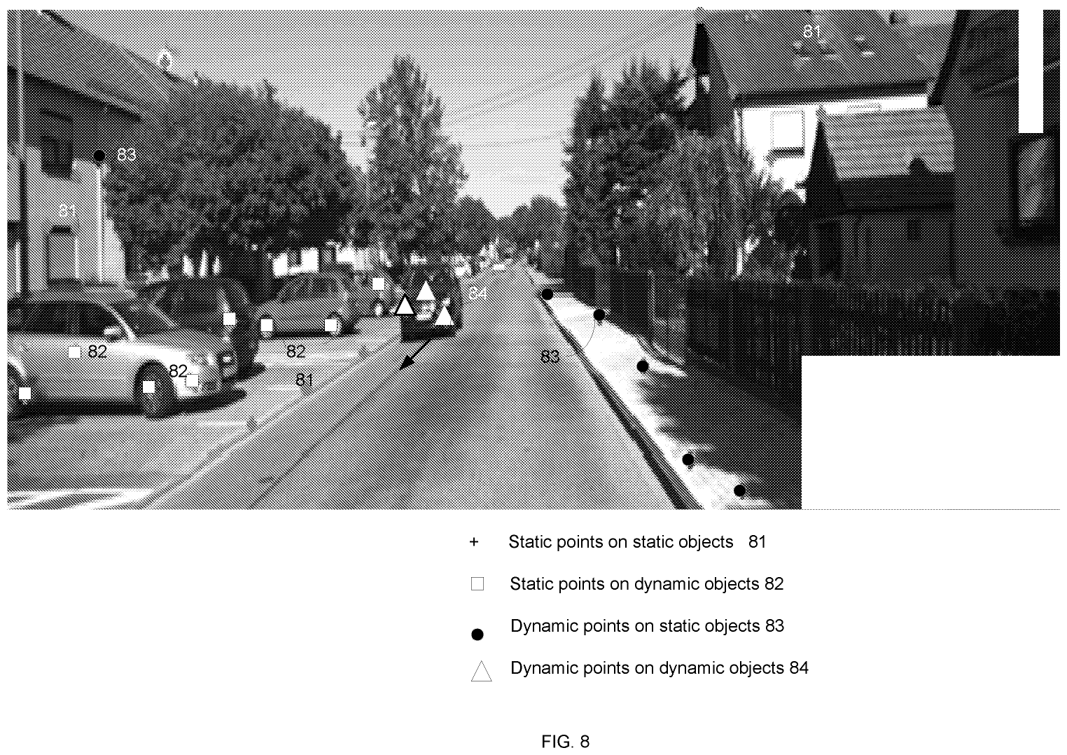

So far, we talked about what distinguishes a POI in a given scene, but our POIs have to be detectable from different viewpoints and at different time of days. We divide the possible POIs into four groups (see for example FIG. 8):

Static points on Static objects (81)—for example: points on buildings, road marks, traffic signs, poles. This kind of points are the best for our purpose. They never move and are easy to find as long as they are not hidden.

Static points on Dynamic objects (82)—for example: points on parking cars. This points can be used for the localization of a given car at a given time because during the time the car drives through the area, the points stay static and are reliable for the process. The problem is that this kind of points will probably move at some point in the future. We can use this kind of POIs in the localization process of multiple cars passing through the area. But we should be extra suspicious about this points, and their reliability. The updating process of the map should be able to erase those POIs from the DDB once they are not reliable anymore (e.g. the parked car has moved)

Dynamic points on Static objects (83)—for examples a shade on the road or a cloud in the sky. This kind of POIs are similar to the 2^{nd} type of POIs described above, the difference is that in this POIs we know a-priori when they become irrelevant and can erase them from the DDB automatically after a known period of time. For example, a point on the road that is distinguishable due to shade of the building falling on the road is static for approx. 1 hour. After that, the shade moves, and the point is not reliable anymore. Another example is a cloud in the sky that can be very disguisable and can be used for localization for multiple cars driving through the area for about 1 minute (depending on the wind). This POIs will enter the DB with an “expiration time” and will be automatically deleted after that time.

Dynamic points on Dynamic objects (84)—for example moving cars or pedestrians. This kind of points are the worst kind for the localization process and cannot be used in any scenario. This kind of POIs will never enter the DDB and cannot be used in the localization process at any time.

Using the above definitions, during the construction of the map only “type 1” POIs are inserted to the DDB. During the update process of the map while cars are driving and using the map “type 2” and “type 3” points can enter and exit the DDB according to their relevance.

Storing the POIs

So far, we discussed how to choose POIs and to classify them. In this section we will talk about what defines a POI, how do we store it in our DB and how do we retrieve the data.

In Image processing there are many ways to save a POI. The most naïve approach is to save the position (u,v) and color (R,G,B) of the pixel for each POI. This is a very poor description of the POI and it will be very hard to discriminate between POIs with such approach. A better solution is to save some neighborhood around the POI (e.g. a 10×10 patch around the POI). This is more informative but is pretty expensive (e.g. for a 10×10 neighborhood we will need to store 10*10*3=300 values per POI), and still get bad result when trying to compare and match between POIs.

Therefore, nowadays, it is common to use “feature descriptors” as a representation for POIs. Feature descriptors encode interesting information into a series of numbers and act as a sort of numerical “fingerprint” that can be used to differentiate one feature from another. Ideally this information would be invariant under image transformation, so we can find the feature again even if the image is transformed in some way. There are many common used features where each has its own pros and cons, naming a few: HOG, SURF, SIFT, Harris, BRISK etc.

A major pitfall of all the above descriptors is there inability to include 3D information in the descriptor. All of the descriptors are based on the image only, therefore they do not incorporate any information regarding the depth or the 3D structure of the POI.

Our descriptor may include a variant of a well-known image descriptor along with some descriptor of the 3D information from our Lidar measurements. By using such a descriptor we wish to detect and match POIs from close viewpoints with better accuracy than by using a pure-image descriptor. We believe that incorporating the 3D knowledge about the 3D structure around the POI will help in detecting and matching POIs under some scene transformation.

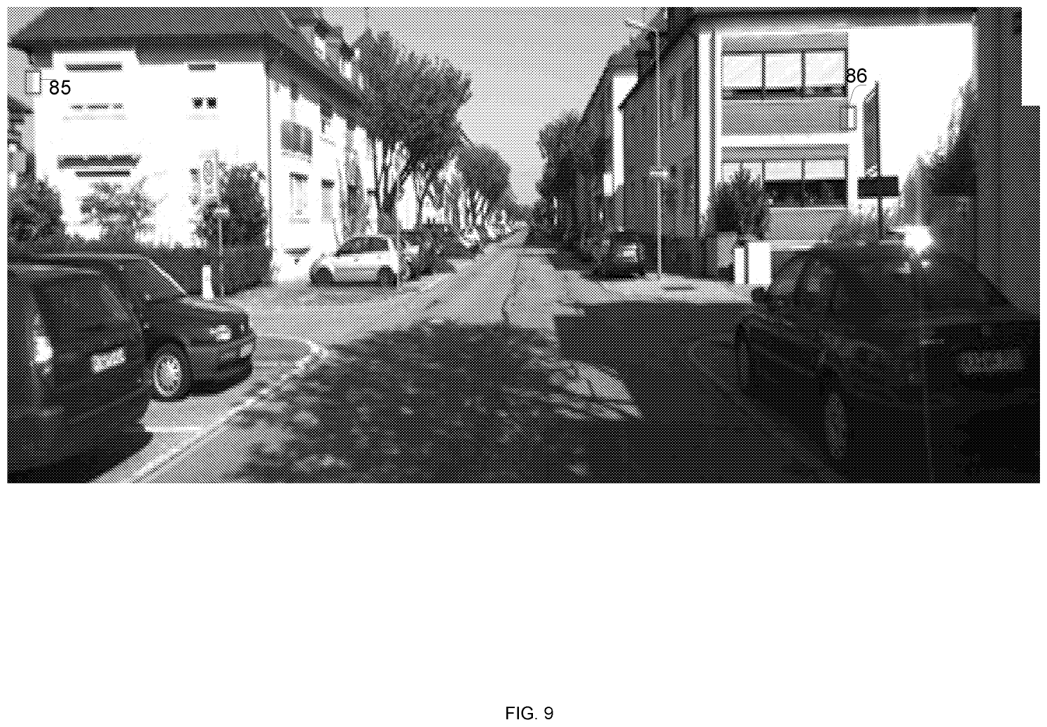

For example, two patches in the image can look very similar and have a very similar descriptor (e.g. SIFT), but their 3D structure may be very different. In FIG. 9, the two patches 84 and 86 share a very similar color values that will probably cause their image-descriptors to be close. But, looking carefully, we notice that the 3D structure of each patch is very different: the right patch 86 is a single plane, while the left patch 85 is only half a plane while the other half is at infinity. An approach that uses a descriptor based on the image alone might fail and consider this two patches as a match. But a descriptor that uses the 3D structure of the scene will easily distinguish between the two. In this case ranges of different points within each patch were calculated and provided the mentioned above information.

Map Construction

A major concern of the localization process is the construction of the initial map. In this chapter we present a couple of approaches to do the initialization process, and in the next chapter we will discuss how to update the map once it's been initialized

Using a mapping-vehicle

One way of constructing the map is to use a special mapping vehicle that will be equipped with a high-end accurate and fast GPS+IMU system. This kind of systems are very expensive and cannot be part of the sensor for each autonomous vehicle. This vehicle will have to drive through all the streets of the city, maybe even a couple of times, and record the scene he sees in each frame.

During the drive a process of detecting POIs will pinpoint interesting and detectable points in the image and use the Lidar to calculate precisely the location of those points in the GPS coordinate system. Each POI will be stored in the DB with the appropriate descriptor (see chapter about Map Structure) and its precise location.

Using a prior model

This approach is an offline initialization of the DDB using a given map of the city and a 3D known model of some static objects on the map. For example we can use the city municipal plans to pinpoint exactly the location of each manhole cover, hydrant, electricity pole, traffic signs, and traffic lights on the map. We can also get the 3D structure of each of the above with a high accuracy. We can use those inputs and generate (manually or automatically) the positions of POIs. Notice that those POIs are “type 1” POIs and can be reliable for the localization process. So at the end of the initialization process we have a full map of the city with many reliable POIs and their precise location in the GPS world coordinates that can be used for the localization process.

Map Updating

Once the map is initialized an autonomous car can drive the area and localize itself using the POIs saved in our DB. But, as mentioned before, the DB is dynamic, POIs enter and exit the DB all the time according to their relevance.

POIs can be removed from the DB once they are not relevant. For example a POI on a parking car will be removed from the DB once the car moves. Another example is a POI generated by a shade of a building on the road, this POI will automatically be deleted from the DB after a known period of time. Another example is a static point on a building that is hidden by a car that parked in front of it. The process of deleting a point from the DB should be supported by reports from multiple cars in order to eliminate noise from random measurements or wrong reports.

POIs can also be added to the DB if they are relevant to other cars. For example, a car just parked on the side of the street and the “type 2” POIs can be used by other cars to localize. A new traffic sign is hanged, and all cars can use it for localization from now on. The process of adding a POI to the DB also needs to be supported from multiple cars, because we do not want to add to the DB temporary POIs that are not reliable. A POI will be added to the DB only after it is been verified by reports from multiple cars.

Furthermore, the position of POIs in the DB can be refined using measurements from the autonomous cars. If a car finds a match to a given POI we can use the measurement of the car to update the position of the POI in our database. The updating process has to consider the possible error in the new measurement and update the POI with the appropriate weight.

The above ideas are summarized in the following algorithm one possible workflow:

The DB Send to the autonomous car the predicted POIs (type 1,2,3) positions and descriptors.

the autonomous car tries to find matches to the given POIs
a. type 1 POI:
i. If match found—the measurement is reported the DB.
ii. If match not found—the POI is reported as “hidden” to the DB.
iii. If found new point that is suspected as type 1—send to DB as “suspect”
b. type 2 POI:
i. If match found—the measurement is reported the DB.
ii. If match not found—the POI is reported as “not relevant” to the DB
iii. If found new point that is suspected as type 2—send to DB as “suspect”
c. Type 3 POI:
i. If match found—the measurement is reported the DB.
ii. If match not found—the POI is reported as “not relevant” to the DB.
iii. If found new point that is suspected as type 3—send to DB as “suspect”

The DB gets the reports from the autonomous car:
a. type 1 POI:
i. If measurement reported—use to update the position of the POI in the DB
ii. If reported “hidden”—decrease POI relevance by 1.
iii. If got new “suspect” point—increase POI relevance by 1, add to the “need to verify list”
b. Type 2 POI:
i. If measurement reported—use to update the position of the POI in the DB
ii. If reported “not relevant”—decrease POI relevance by 2.
iii. If got new “suspect” point—increase POI relevance by 1, add to the “need to verify list”.
c. Type 3 POI:
i. If measurement reported—use to update the position of the POI in the DB
ii. If reported “not relevant”—decrease POI relevance by 3.
iii. If got new “suspect” point—add to the “need to verify list”.

Add POI to DB once they reach relevance value>R (R-parameter).

Remove POIs from DB once they reach relevance value==0.

(optional) Send to the car request to measure POIs that are in the “need to verify list”.

Localization process

The localization of the car is the process of finding the transformation of the camera in the current frame in respect to some origin. If we consider the “car's coordinate system” then the localization is in respect to the starting position of the drive we need only local Lidar measurements of our POIs. If we consider the “world coordinate system” we also need the global GPS location of each POIs.

Localization (car coordinate system)

In order to find the location of the car on the map during driving, the system will apply SLAM (Self-Localization and Mapping).

Algorithms for SLAM are generally well known. Typically they predict the car location at time t, using the predicted location at time t−1, and new sensor data sensed at time t−1. Sensor data can include, for example, camera frames, Lidar point cloud and GPS measurements. The prediction of the car location at time t, can be a weighted average of the predicted position at time t, and a prediction made from the senor data sensed at time t−1. Well-known implementations of SLAM are based on extended Kalman filters.

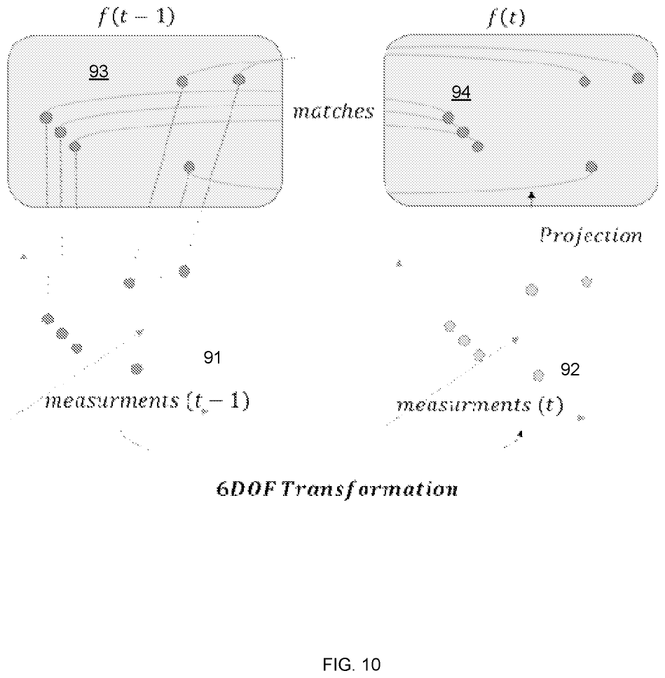

FIG. 10 illustrates measurements 91 in (t−1), measurements in (t) 92, the projections 93 and 94 of the mapping, and finding the match between the matches.

An important distinction is that we may have in the DDB objects that are not strictly needed. They will be there because they help the car find its location on the map. So, for example, a pole that is distinct and easy to find may be added to the map just for that purpose.

Localization (world coordinate system)

The process of finding the exact location of the camera given an image of the scene is called localization. We suggest the following process:

Given our POIs map, and an inaccurate position of the car (e.g. estimated using GPS or previous position) we can estimate a rough position of each POI in the image.

Look for the POI in the image in a window around the predicted location of that point. If the POI is not occluded or hidden it should be visible and can be recognized.

Point and shoot an accurate LIDAR exactly to the POI direction and determine its exact 3D location.

We repeat the process for each of the visible POIs we found in the image.

Next we use a smart elimination algorithm (described below) to choose a subset of the POIs to use for the localization process.

We compute the accurate position of the car using the reliable POIs.

Update the POIs reliability in the map for next iterations.

The Elimination algorithm's purpose is to choose only the most reliable POIs in each scene and to base our localization on those points only. This will make the localization process much more robust to outliers and misdetections:

The main insight relies on the fact that the real 3D distance between POIs is constant and it doesn't change over time or place.

As said, in each frame where we try to find the location of the camera, we will try to find POIs in the image for which we know the 3D coordinates. The fact that the pairwise distance between each pair of points is known a-priori can be used to eliminate wrong matching.

Moreover, we can use only the POIs that are most reliable, meaning that the distance between them to the other points was closest to what we know a-priori.

Furthermore, we can use the fact that the POIs are static and should appear in every scene to update the map if a POI is missing. For example, assume we have a POI in a traffic sign and we always use it to find our geo-location. On the next day, the traffic sign was moved. So now, the pairwise distances between this POI and the other POIs will be different (the other distances remain the same). In such a scenario, we can conclude that this POI is not valid anymore and we need to update the ‘static POI map’.

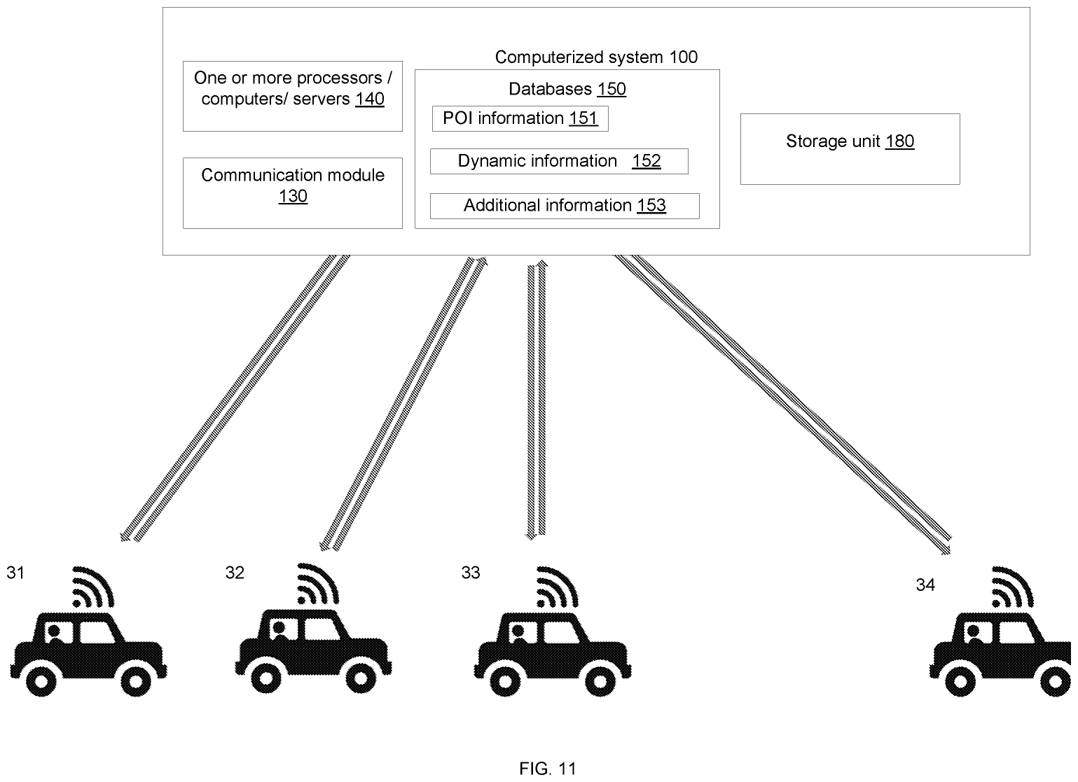

FIG. 11 illustrates a computerized system 100 that includes databases 150 (POI information 151, dynamic database 152 and additional information 153). communication module 130, and one or more processors/computers/servers 140.

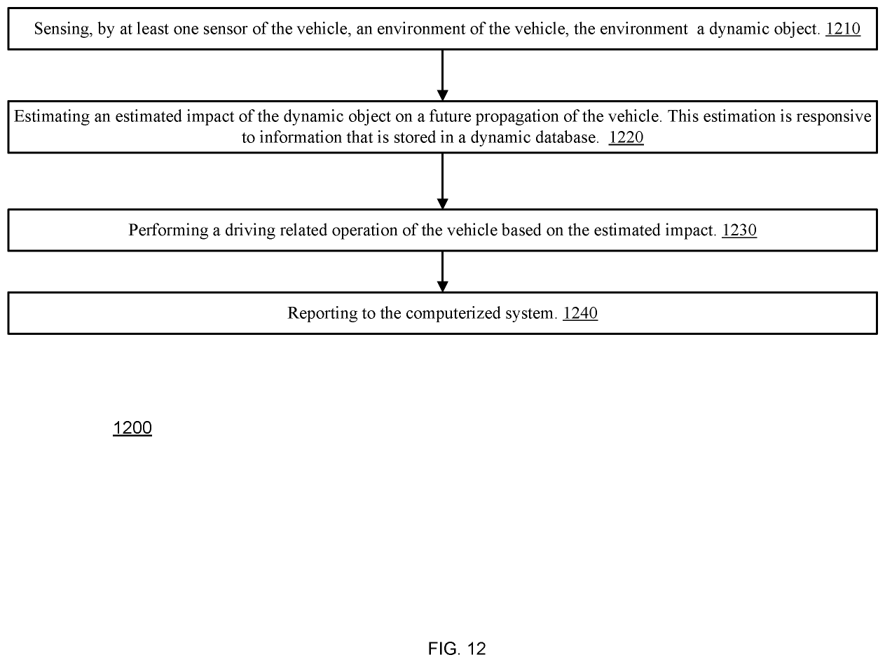

FIG. 12 illustrates method 1200 for operating a vehicle.

Method 1200 may include steps 1210, 1220, 1230 and 1240.

Step 1210 may include sensing, by at least one sensor of the vehicle, an environment of the vehicle, the environment may include a dynamic object.

The environment may be captured within one or more fields of view of one or more sensors of the vehicles. A sensor may capture only parts of the environment—for example may sense information related to points of interest that form only a part of the entire field of view.

The sensors may sense any type of radiation (visual, Infrared, near infrared, radio frequency, acoustic, and the like), may be passive sensors, active sensors, or any type of sensors—such as but not limited to radars, lidar systems, cameras, and the like.

A vehicle may include any number (or or multiple) of sensors of any type of sensors. The vehicle may include a single type of sensors or multiple types of sensors.

Step 1210 may include sensing signals associated with one or more groups of points of interest within the environment. This may include illuminating the points of interest (when using active sensors)—or not (when using passive sensors).

Step 1210 may include (or may be preceded by) retrieving information about locations of the points of interest of the group. The information may be stored in a computerized system outside the vehicle.

Step 1210 may be followed by estimating a quality of the points of interest of the group. The estimation may include evaluating whether the element that appears in the point of interest can be detected, whether the sensor received any reflected or scattered signal as a result of illuminating or sensing the point of interest, whether the information obtained from the point of interest can be used for navigation, whether the element including the point of interest is unique and/or distinguishable from its environment, whether the signals received from the point of interest are of sufficient signal to noise ratio or sufficient intensity, the extent to which signals sensed in multiple sensors from the same point of interest, agree, the persistence of the point of interest over multiple frames, or multiple illuminations and the like.

An algorithm to calculate the quality of the point of interest is:

1. Choose a set of features of the point of interest. A feature may be the contrast of the feature with its surroundings, or the similarity between the detected signal from the point of interest and retrieved information about the point of interest. The features may depend on the sensor assigned to sense the point of interest.

2. Calculate a normalized score for each feature of the point of interest.

3. Calculate the quality of the point of interest as a weighted sum of the normalized scores of the features of the point of interest.

There may be different types of points of interest. For example, at least one point of interest may be relevant within reoccurring (or non-reoccurring) time windows and may be irrelevant outside the one or more reoccurring (or non-reoccurring) time windows.

The determination of the points of interest for one type of sensors may be determined based on at least one out of (a) information about points of interest that is stored in the computerized system, and (b) information obtained by at least one other type of vehicle sensor. For example—an image, or images, acquired by a camera of the vehicle may be processed in order to find suggested points of interest for a radar and/or a lidar system.

The method may include at least one out of:
a. Preferring the suggested points of interest found by processing the image, or images (selecting all of the points of interest or at least a majority of the points of interest based on the processing of the image).
b. Preferring the points of interest stored in the computerized system (selecting all of the points of interest or at least a majority of the points of interest based on the points of interest stored in the computerized system).
c. Selecting at least some of the points of interest based on the quality of the points of interest.
d. Applying any selection criteria, such as the quality, spatial and, or temporal separation, detection in multiple sensor types.

Method 1200 may also include selecting which type of vehicle sensor to use for sensing the environment of the vehicle based on at least one out of an actual or estimated status of the environment.

For example—bad visibility may require using a radar.

Step 1220 may include estimating an estimated impact of the dynamic object on a future propagation of the vehicle.

The dynamic object (especially—the estimated progress of the dynamic object) may not affect the future propagation of the vehicle, may endanger the vehicle, may endanger itself, may cause an accident unless the vehicle changes its future propagation, may require the vehicle to bypass the dynamic object, or may affect in any other manner the future propagation of the vehicle.

The estimation of the estimated impact may include estimating the future behavior of the dynamic object. This estimation is responsive to information that is stored in a dynamic database. The vehicle receives the information before the estimation is made. The vehicle may monitor the actual behavior of the dynamic object and may update the dynamic database accordingly.

The information provided by the dynamic database may be acquired at different locations. Information related expected behaviors of dynamic objects related to a certain location, may be generated based on behaviors of other dynamic objects at the certain location, or at similar locations or at prototype locations, or only from the certain location, wherein information about the behaviors of the other dynamic objects are stored in dynamic database and later distributed to vehicles.

Step 1230 of performing a driving related operation of the vehicle based on the estimated impact.

Step 1230 may include at least one of the following:
a. Autonomously driving the vehicle. This may involve maintaining the original driving patters or changing the original driving pattern.
b. Changing a mode of operation of the vehicle between an autonomous driving mode and a non-autonomous driving mode.
c. Generating a driver perceivable alert.
d. Reducing a velocity of the vehicle—stopping the vehicle or reducing the velocity without stopping.
e. Changing the future propagation of the vehicle in order to acquire a better sensing of the dynamic object

Regarding option (e)—
a. The changing of the future propagation of the vehicle may include moving from one lane to the other and/or moving within the same lane. The movement may be determined by a processor that is installed in the vehicle or by a computerized system installed outside the vehicle.
b. The changing of the future propagation of the vehicle may be determined based on the previously acquired information about the dynamic object.
c. For example—having stored images from some angles—and missing images from other angles—and sensing the dynamic object from these dynamic object.
d. The changing of the future propagation of the vehicle may be determined based on an ambiguity related to the dynamic object—that may be solved if the dynamic object is sensed from another direction.
e. A memory unit may store, for each dynamic object and/or for each type of dynamic objects (vehicles, persons, . . . ) the required sensed information—and if some of said required sensed information is missing—the changing of the future propagation may take it into account.
f. The changing of the future propagation of the vehicle can be made in order to sense a concealed object (dynamic or static) that is currently fully or partially concealed from the sensors of the vehicle. The presence of the concealed object can be detected by the sensors of the vehicle when the object is only partially masked. The presence of the concealed object can be fed to the vehicle by other vehicles and/or can be indicated by the dynamic database (in case of a dynamic object) or by any other database available to a computerized system installed in the vehicle or outside the vehicle.

A computerized system located in the vehicle and/or a computerized system located outside the vehicle may request different vehicles to sense a dynamic and/or static objects from different directions—for example may request vehicles that drive at different lanes to sense the dynamic and/or static object. The acquisition of images from different direction may assist in identifying the object, in providing a better analysis of the object or for any other purpose.

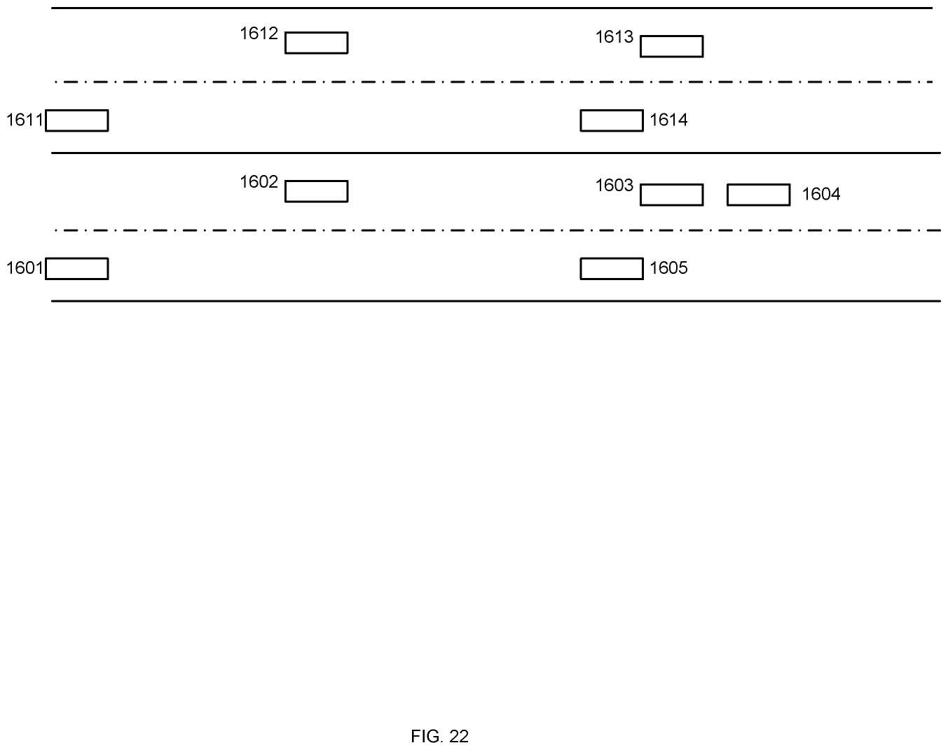

For example—referring to FIG. 22—vehicle 1602 may acquire an image (or otherwise sense) vehicle 1603. Vehicle 1602 can hardly see (or can not see vehicle 1604). Vehicle 1602 or a computerized system located outside the vehicles (for example the computerized system that manages the dynamic database) may request other vehicles for example—those driving at different lanes, those driving at different direction, or even those driving at the same lane but precede or follow vehicle 1602 to sense vehicle 1604. Such a request may be generated in relation to any dynamic or static object.

Vehicle 1602 or a computerized system located outside the vehicles (for example the computerized system that manages the dynamic database) may request other vehicles to maintain their progress or change their propagation (for example change lane, change position within lane) in order to image vehicle 1604.

Step 1240 may include reporting to the computerized system.

The reporting may be executed each time step 1220 is executed—but this is not necessarily so.

For example—the method may include determining whether to report at least one of the changes.

The determining may be based on one or more parameters such as the status of one or more communication links between the vehicle and the computerized system, the density of traffic (more vehicles may imply that the network and/or the computerized system are busy), whether there is a difference between the expected behavior of the dynamic object and the sensed behavior, the amount of difference, the load imposed on a communication module of the vehicle, and the like.

The decision on whether to report at least one of the changes may depend on a calculated uncertainty of the detection. At time t, the uncertainty to may be too high to report the change, whereas by time t+1, the calculated uncertainty is lower than some uncertainty threshold, and the change can be reported.

The reporting may include reporting information related to at least one out of the dynamic object, a static object, an absence of a movable object from a road included in the environment, an estimated impact of the dynamic object on the future propagation of the vehicle, a risk map, points of interest, and the like.

The method may include receiving or generating a risk map and updating the risk map with the estimated impact of the dynamic object on the future propagation of the vehicle. The risk map may provide risk related parameters (such as the level of risk) to all or some of the locations along the path of the vehicle.

Step 1240 may include transmitting information about the environment of the vehicle (information sensed by one or more sensors of the vehicle) to a computerized system that is positioned outside the vehicle.

Method 1200 may include generating the information about the environment by applying privacy protection measures.

The applying of the privacy protection measures may include masking at least one out of vehicle identifying information and people identifying information. For example—image processing may be applied on images acquired by a vehicle camera—and faces may be recognized (facial recognition) or at least be detected—and masked from the transmitted image. The same may apply to the license number of a vehicle or any identifying information.

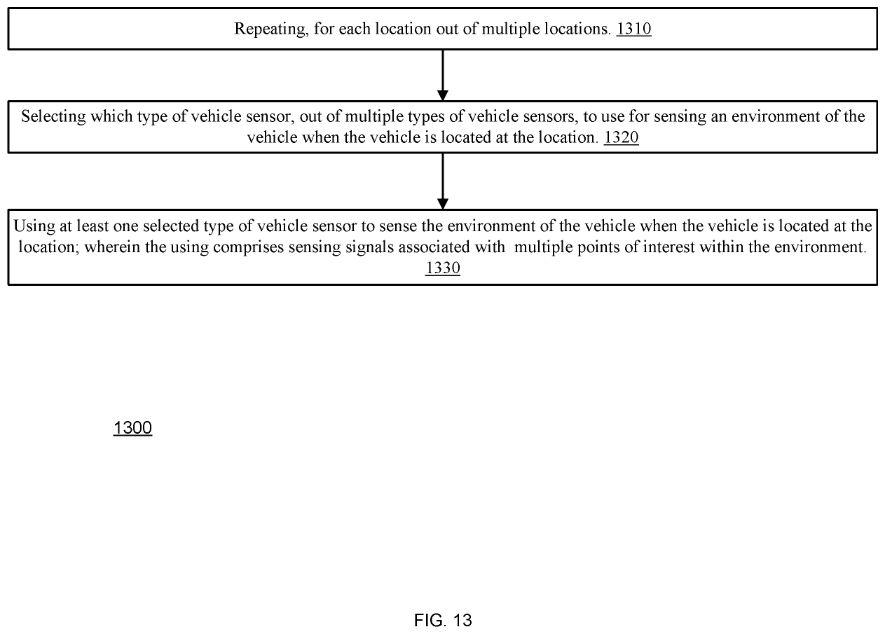

FIG. 13 illustrates method 1300.

Method 1300 may include steps 1310, 1320 and 1330.

Step 1310 may include repeating, for each location out of multiple locations, the steps of:
a. Step 1320 of selecting which type of vehicle sensor, out of multiple types of vehicle sensors, to use for sensing an environment of the vehicle when the vehicle is located at the location.
b. Step 1330 of using at least one selected type of vehicle sensor to sense the environment of the vehicle when the vehicle is located at the location; wherein the using may include sensing signals associated with multiple points of interest within the environment.

The multiple locations may form the entire path of a vehicle, or may form only some of the path. The repetition may be repeated per each time period, when the vehicle passes a certain distance, per junction, per day, per hour, per a change in a visibility condition, and the like.

The multiple types of vehicle sensors may include a camera, a light detection and ranging (lidar) sensor and a radio frequency radar.

The method may include estimating a quality of at least some of the multiple points of interest.

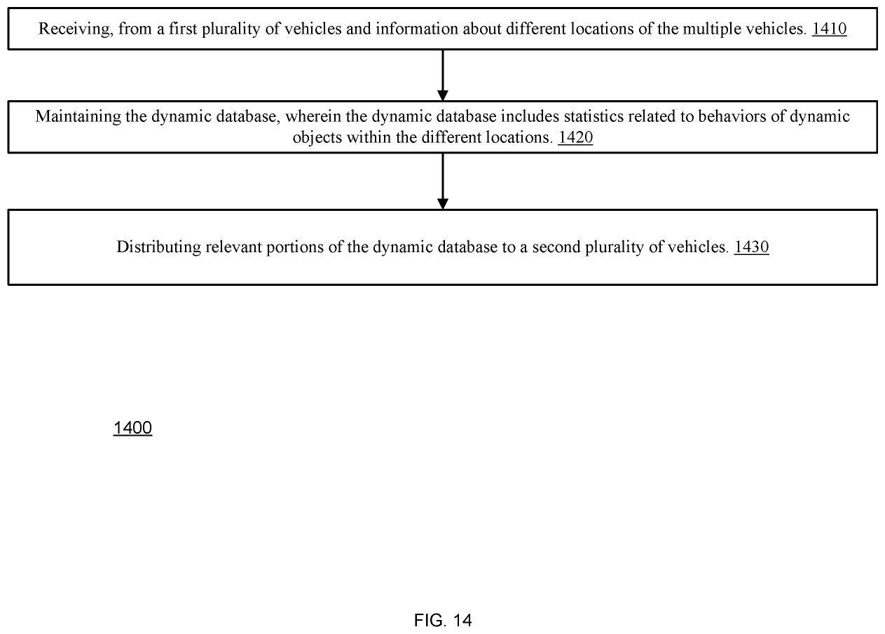

FIG. 14 illustrates method 1400.

Method 1400 may include steps 1410, 1420 and 1430.

Method 1400 is for maintaining a dynamic database. The maintaining may include building the dynamic database and even updating the dynamic database. The dynamic database may be the DDB mentioned above.

FIG. 14 may be executed by a computerized system that is located outside the vehicle.

Step 1410 may include receiving, from a first plurality of vehicles and information about different locations of the multiple vehicles.

A vehicle may acquire information about the environment (raw data), may process it in various manners (for example noise reduction processing, feature extraction, event detection) and may send to the computerized system the raw data or processed data. The processed data—for example event information that identifies the event may be smaller than the raw data.

Accordingly—step 1410 may include receiving raw data sensed by vehicle sensors of at least one vehicle of the first plurality of vehicles and receiving event information from at least one other vehicle of the first plurality of vehicles.

Step 1410 may include receiving information from a vehicle about a mismatch between information sensed by the vehicle about a location of the different locations and information of the dynamic database about the location.

Step 1410 may include receiving information from a vehicle about a mismatch between an actual behavior of a dynamic object within a location and statistics, included in the dynamic database, about the dynamic object within the location.

Step 1420 may include maintaining the dynamic database, wherein the dynamic database includes statistics related to behaviors of dynamic objects within the different locations.

The first plurality of vehicles and the second plurality of vehicles may include the same vehicles or may differ from each other by their vehicles. The number of vehicles in the first and second plurality of vehicles may be any number—although it is beneficial to obtain information from many vehicle as possible.

Step 1420 may include at least one of the following:
a. Classifying the different locations to prototype locations and maintaining statistics per prototype location.
b. Maintaining statistics per locations that are similar to each other.
c. Classifying locations to classes and maintaining statistics per class, wherein a classification of at least one class is responsive to an amount of data obtained in relation to one or more locations that belong to the class.
d. Requesting a vehicle to provide information regarding a new location not included in the multiple locations.
e. Requesting a vehicle to provide information regarding a quality of one or more points of interest illuminated by the vehicle.
f. Requesting a vehicle to provide information regarding a behavior of one or more dynamic objects within one or more locations within one or more future time windows.
g. Requesting a vehicle to change a position of the vehicle to a certain position and requesting the vehicle to obtain information from the certain location.
h. Requesting a vehicle to provide information regarding points of interest.

Any response to these requests may be received during step 1410 and then processed during step 1420.

Step 1420 may include maintaining in the dynamic database points of interest information about groups of points of interests, wherein each group is associated with a location of the different locations.

Two or more groups may be associated with a same location and with two or more types of vehicle sensors.

The points of interest information may include location information about an absolute location of the points of interest.

The points of interest may include static points of interest on static objects and at least one out of (a) static points of interest on dynamic objects, and (b) dynamic points of interest on static objects.

The points of interest information may include two-dimension location information and distance information.

Each point of interest may represent a segment of the object and wherein the distance information represents distances to multiple parts of the segment.

Step 1430 may include distributing relevant portions of the dynamic database to a second plurality of vehicles.

Multiple repetitions of steps 1410, 1420 and 1430 may be executed. For example, the dynamic database may be updated by information provided during step 1410. One or more vehicles and the computerized system that maintains the dynamic database may exchange information, requests and queries.

Step 1430 may include determining a relevant portion of the dynamic database to be sent to vehicle of the second plurality of vehicles based on a location of the vehicle and a cost associated with a transmission to the vehicle.

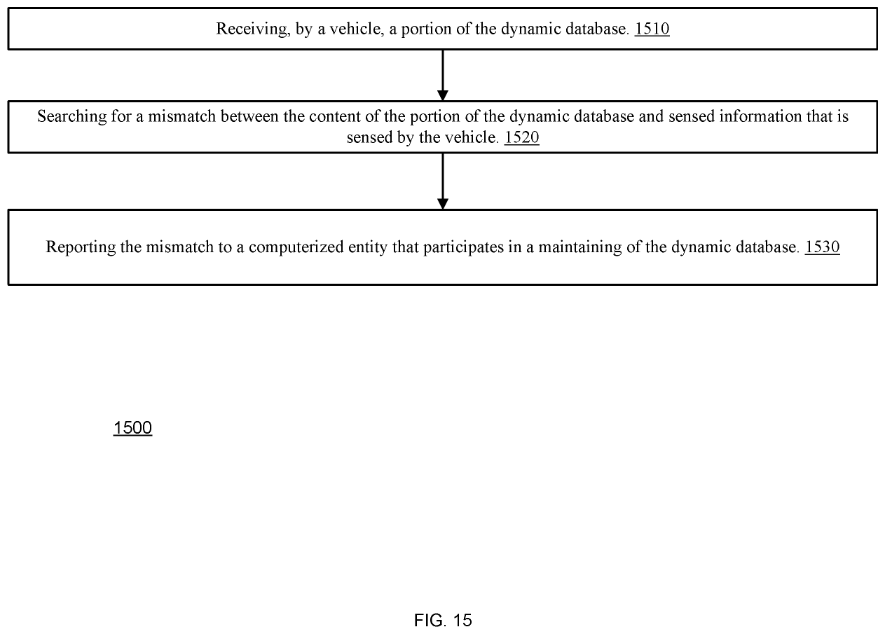

FIG. 15 illustrates method 1500.

Method 1500 may include steps 1510, 1520 and 1530.

Method 1500 is for assisting in an update of dynamic database.

Step 1510 may include receiving, by a vehicle, a portion of the dynamic database. The dynamic database may be any of the dynamic databases mentioned above. It may include statistics related to behaviors of dynamic objects within the different locations.

Step 1520 may include searching for a mismatch between the content of the portion of the dynamic database and sensed information that is sensed by the vehicle.

Step 1530 may include reporting the mismatch to a computerized entity that participates in a maintaining of the dynamic database.

The dynamic data base may include information about groups of points of interests, wherein each group is associated with a location of the different locations.

Method 1500 may also include sending information about a quality of one or more points of interest to the database.

Communication Between Autonomous Car and Drivers

The next years will see on the road autonomous cars as well as real drivers driving side by side. In order to do that safely and efficiently both sides need to understand the predicted behavior of the other hence the driver will need to understand the predicted behavior of the autonomous car and drive accordingly and the vice versa. Both sides will need also to signal each other similar to the way it is done today with real drivers.

The communication may be preceded by understanding driver and driver intention and exhibiting them.

This may include, detecting dangerous drivers (distracted—for example typing SMS messages, intoxicated and/or tired).

There are various in-vehicle systems that monitor the driver of the vehicle and may generate warnings—including warning the driver of drowsiness, intoxication, distracted and so forth.

A person of another vehicle may be capable of tracking a movement of a car and at least suspect that the driver is behaving strangely. The tracker may not know the exact reason (drunk, on drugs, tired, SMS) but it can spot those patterns and analyze them. This is very important to regular drivers and to self-driving cars, usually giving more space to those cars. In car to car communication this information should be conveyed. The standard signals of dangerous drivers is corrections of direction that are violent, shifting within the lanes.

There is provided a system and method for detecting a dangerous driver of another vehicle. Specifically, the system and method may do so even without the assistance of the driver of the other vehicle.

The method may include:
a. Detecting the car type and make. This can be done using image processing of an image of the car. The processing may include, for example, comparing it to a car database.
b. Measuring accurately the movement of the car. The monitoring period may last few seconds (for example between 1 and 20 seconds). If the monitoring car the the monitored can drive in the same direction it may be easier to maintain enough information.
c. Calculating the way the driver is manipulating the driving wheel from the car model and the car movement. Given that we observe the car movement in detail the method may estimate the steering wheel movement as done by the driver from the observed movement of the car
d. Apply any of the algorithms that detect driver drowsiness and other risk from the handling of the wheel. This may involve using new algorithms- or already algorithms that were developed for monitoring the vehicle itself—and not for monitoring another vehicle. The method may use existing, tested algorithms meant to reside in the car, from outside the car, to learn on its driver condition. For example, an algorithm may include analyzing the lateral variation of the other vehicle, and comparing it to a lateral variation threshold. Such a threshold can be constant, or can be retrieved from the DDB. The DDB may hold information such as the expected lateral variation in one location which may be different from the expected lateral variation in another location. Another algorithm may analyze the speed variation of the other vehicle.

This technology is useful both for self-driving cars and regular car. Knowing that another driver is drowsy or drunk may be very useful.

Devine Driver Intention from the Way the Car is Moving

When we drive, we all the time assess the intentions of the cars around us, and show our intentions by the way we drive. For example, when we try to get into a busy street we publish our intention by using the relevant blinkers but by also inching into the street. Others, by the way they drive, tell us if they are willing to let us in. We can try forcefully to go in, in which case they will usually back off.

A conversation exists when driving between the different cars, using the car to show the intention of the driver. When a human driver tries to change lane, he may indicate that you want and as a result a car may slowdown and let you, in which case you take the offer. If you want till there is a break, in some places you will never get it. Some driver show intention aggressively, some do not use the signals.

As a pedestrian trying to cross the road, we publish our intention, and if possible will try to get eye contact with the driver, to see he acknowledges our existence. If we get it we can start to walk safely, if not we may wait or try other means. If a car is before intersection, slowing may mean a turn. Lots of information on intent is given and received between drivers and is essential to the way human driven cars interact.

The obvious thing is to look at the car signals. See http://www.dailymail.co.uk/sciencetech/article-3539399/Google-s-self-driving-cars-soon-predict-drivers-going-Patent-reveals-plans-sensors-detect-turn-signals-braking-lights.html.

The suggested method may sense additional information that is related to the way the person drives, or looks. This is especially important when one tries to ease into traffic. Waiting until it is safe, no cars in the area can be very slow. Usually cars will indicate (the drivers will) that they let you in by slowing down a bit, if you take advantage they will slow down more as necessary. A person will go into traffic looking at the car to see if it behaves as expected (the expectation is to slow down sufficiently to let him ease in) if it does not he will not completely go into traffic.

In many cases, it will be part of a car to car conversation (one trying to get into traffic and the other decide if to let it). So, the divining could be for the car trying to get in (will the other car let me) or for the car driving (this guy is really trying to get in). The main way to calculate driver intention is by sensing and analyzing visual cues, and comparing situations.

For example, someone driving intending to continue will usually drive in the middle of the lane at a fairly constant speed. Someone about to turn a lane to the right (in addition or independently of using the turning light) will be in the right side of the lane. Possible on the lane border. Of course, he may be a bad driver, or drunk, or SMSing but may also be trying to pass lane. Someone intending to take a turn, will slow down. Someone trying to break into traffic, for example from a driveway, will inch his way forward. Making a small obstacle with his car indicating that he wants to get in. He would also look intently at the car that may response. Upon getting a signal (car slowing down for him for example) we will see his attention shift to the road.

In general, we are looking for different driving than the normal, if we see it, it may indicate a problem, but it may also indicate intention. The indication of intention itself is done using the norms of driving in the specific location and may be different between countries, and even places in the countries. The discussion here is not of the commonly used ways to signal that are taught for driving exams such as the turn signals but of the communication signals between drivers. In addition to the above they may include flashing of lights (I want to go ahead, or in some other places, you can go ahead), and nod of the head, smile, all used by people to divine intentions.

Indicating Intent for a Self-Driving Car

Even self-driving car may be required to move in such a way as to indicate its intent, in a human like way—so that other cars and pedestrian can read it. For example, it may slow down, veer or do the other things drivers do that other drivers read. Additionally of alternatively, the self-driving car may be equipped with an impression of a head, that the passenger will know saw him, looking at him.

An interesting analogy is silent cars (electric). There are laws that they need to make noise as this is the interface people expect from cars. Otherwise it is not safe (people go into the road without looking, as they are used to hearing the car). Same could be for driving in a way that a person could read intent like from other people, so even if you can take the curb at a high speed (higher than average driver), and it is legal, you should slow to indicate that you turn.

If you see a car trying to go into traffic, you need to decide how polite you are. If you are polite, you can let it go into traffic, and need to indicate it from the way you drive. This is true for self-driving cars as well.

Indicating Asking to Receive and Giving Right of Way:

When a self-driving car sees someone trying to inch into traffic, and it is willing to let him in, it can indicate it in the same way people do. Slowing down, flashing lights and other indication relevant to the location it is driving in. For a self-driving car, the intention of another car to inch into traffic, is translated into variations in detected object behavior, or unexpected variations in driving free space. For example, a merging car, will tend to have a high lateral velocity vector than a car driving longitudinally. Or the driving free space, may be convex, where it would have been expected to be straight. These variations in the behavior of dynamic and static objects need to be understood together, and interpreted as “car trying to inch into traffic”.

When the self-driving car wants to break into traffic (for example going from a side road to a major busy road) it needs to indicate that it wants to, and ask for permission. This will be done in the same way as people in that location. Inching forward moving into traffic when the action is reversible. If the other car decided not to give right of way, not forcing it.

Turning

People indicate that they are about to turn using signals and by changing speed. As the self-driving car is not expected to forget to use the turn signal, it may decide not to change speed as much as a human driver when turning. However, there is an advantage to doing so as it is visible and understood also by people who do not see the turn signals.

Understand Wheel Usage from Car Behavior

Looking at a car moving, knowing the road and the car, we can reverse engineer the wheel movement as done by the driver. Now any application that takes wheel movement into account (like drowsiness and fatigue detection http://pid.sagepub.com/content/229/2/163.abstract) and maybe other things, can be done from outside the car. The advantage is that we can take legacy application done in the car do detect something about the driver, and use the same algorithm but we get the wheel movement from the patented component.

There may be provided a method that may include:
a. Collecting multiple algorithms that detect driver condition from wheel movements.
b. Observing the car driving using sensors.
c. Using the observation, and the car model, calculating the steering wheel movement.
d. Applying one or more algorithms to detect driver condition from the calculated steering wheel movements.
e. Impacting driving decisions based on our evaluation of driver conditions of that car.

Change to the Way You Drive Based on Local Customs

It is suggested that self-driving cars will change the manner they drive to indicate their intentions (regarding driving), and there may be provided a method for learning on the intentions of other drivers from the way they drive. They idea is that self-driving cars should, like normal drivers, receive and deliver intent information based on driving patterns. This has multiple advantages as described above.

However, the communication language between cars is not universal and may depend on location (drivers of different places may be accustomed to different driving habits). So, like self-driving cars need to observe different rules in different places, they will need to know the local customs for this type of communications in order to communicate effectively. It is likely that different modes will be used in Seattle and Bombay for example.

Bullying Self-Driving Cars

Self-driving cars are expected to be bullied by human drivers when the two are sharing road space. While driverless cars will be programmed to be law-abiding and considerate road-users, their human counterparts will be much more aggressive.”

Part of this expectation is that self-driving cars will be different, will not use the car to car communication described in this application to co-ordinate with others. If they do, they are likely to be bullied a lot less.

In order to reduce the chances of being bullied self-driving cars may provides more indications about indications to change lanes and/or remain in the same lane by changing their driving (velocity, location within a lane) to indicate (even to a human driver) about their future projection.

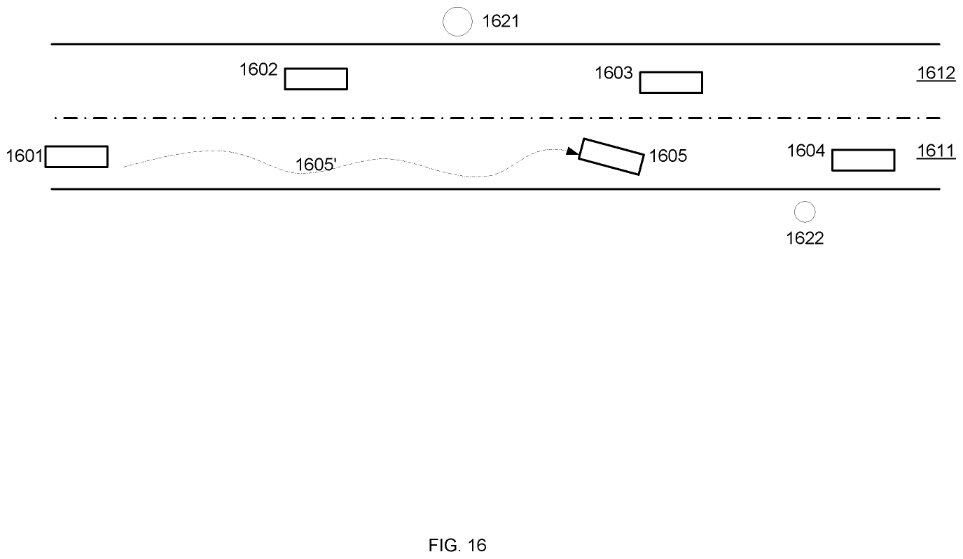

FIG. 16 illustrates a vehicle 1605 that progresses in a problematic manner (see pattern 1605′)—as it repetitively changes its location within lane 1611 without any justification.

The movement of vehicle 1605 is monitored by vehicle 1601. Vehicle 1601 may notice the problematic progress of vehicle 1605, may detect that the driver is intoxicated, tired and/or is distracted and may change its progress and/or may alert at least one out of the driver of vehicle 1605, vehicle 1605, the driver of vehicle 1602 (driving within lane 1612), vehicle 1602, the driver of vehicle 1603, vehicle 1603, the driver of vehicle 1604, vehicle 1604, pedestrian 1621 and pedestrian 1622.

The alert can be sent using any type of communication—vehicle to vehicle communication, human perceivable communication and the like.

A request can be made to the driver of vehicle 1605 and/or to vehicle 1605 to change the mode of driving from non-autonomous to autonomous.

The request may be sent by at least one out of the driver of vehicle 1601, vehicle 1601, the driver of vehicle 1602, vehicle 1602, the driver of vehicle 1603, vehicle 1603, the driver of vehicle 1604, vehicle 1604, pedestrian 1621 and pedestrian 1622.

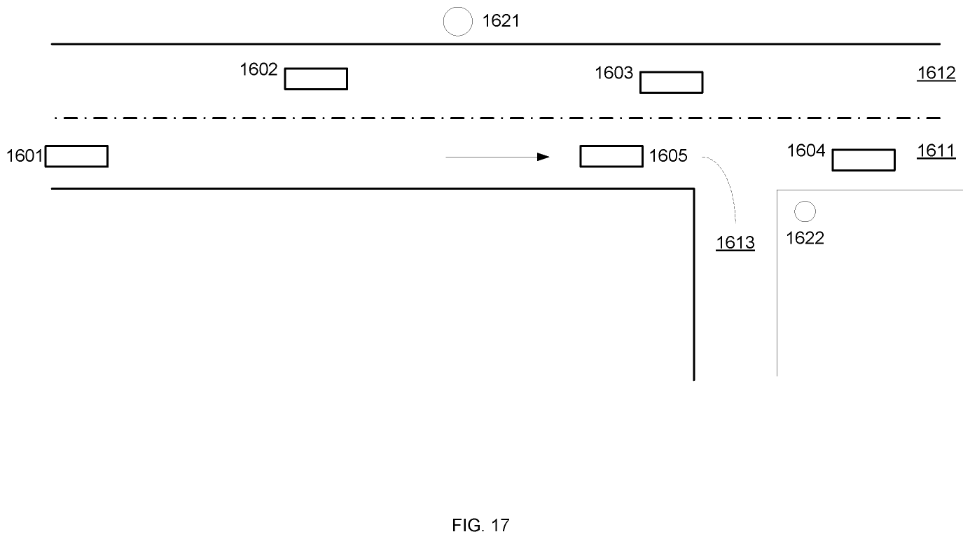

FIG. 17 illustrates a vehicle 1605 that approaches a turn 1613—and there is a need to estimate whether the vehicle 1605 intends to turn. The vehicle 1605 may operate (when approaching turn 1613) in an autonomous mode and may alter its behavior to indicate to human drivers that it intends to turn. The alteration may include signaling and performing at least one operation out of slowing down, transmitting a turn alert (not using the lights), getting closer to the right edge of lane 1611, and the like.

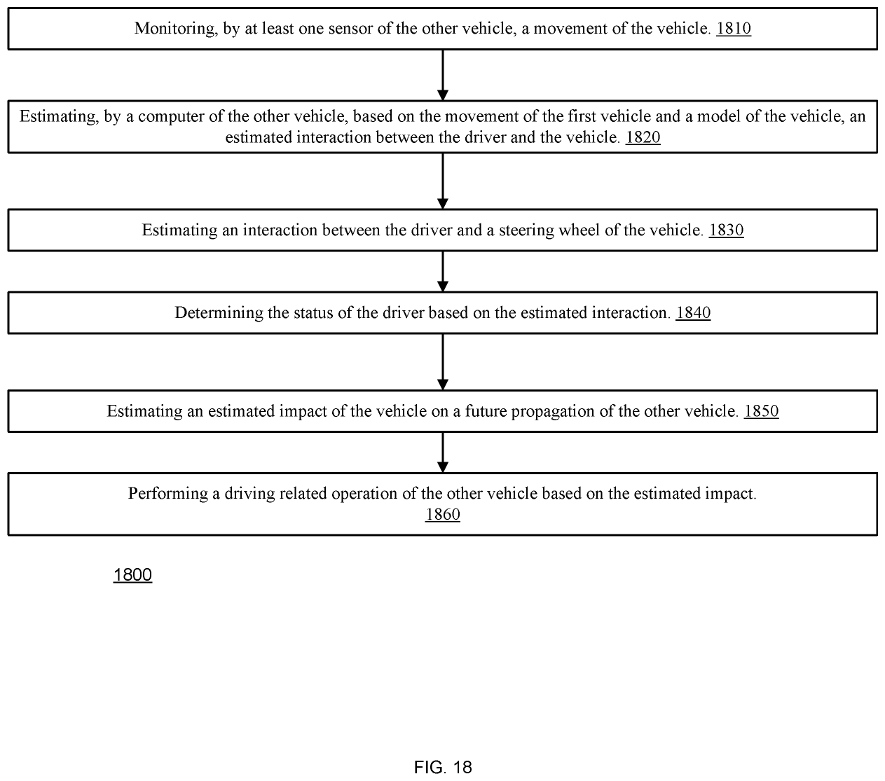

FIG. 18 illustrates method 1800 for monitoring a vehicle and operating another vehicle.

Method 1800 may include steps 1810, 1820, 1820, 1830, 1840, 1850 and 1860.

Step 1810 may include monitoring, by at least one sensor of the other vehicle, a movement of the vehicle.

Step 1820 may include estimating, by a computer of the other vehicle, based on the movement of the first vehicle and a model of the vehicle, an estimated interaction between the driver and the vehicle.

Step 1820 may include estimating an interaction between the driver and a steering wheel of the vehicle. Such estimation may be based on analyzing together the behavior of dynamic (the other vehicle) and static objects (the driving free space) and checking whether they match a known pattern of driving (drunk driving, inching into traffic). One algorithm for determining the relationship between the behavior of dynamic and static objects, and patterns of behavior, is to use a deep neural network to learn that relationship.

Step 1830 may include determining the status of the driver based on the estimated interaction.

Step 1830 may include at least one out of
a. Applying a drowsiness detection process.
b. Applying a fatigue detection process.
c. Applying a driving while intoxicated detection process.

Step 1840 may include estimating an estimated impact of the vehicle on a future propagation of the other vehicle.

Step 1850 may include performing a driving related operation of the other vehicle based on the estimated impact.

Step 1860 may include at least one out of
a. Autonomously generating an alert that is perceivable by the driver of the vehicle.
b. Autonomously generating an alert that is perceivable by one or more other vehicles.
c. Requesting the vehicle, by the other vehicle, to change a mode of operation of the other vehicle from a non-autonomous driving mode to an autonomous driving mode.

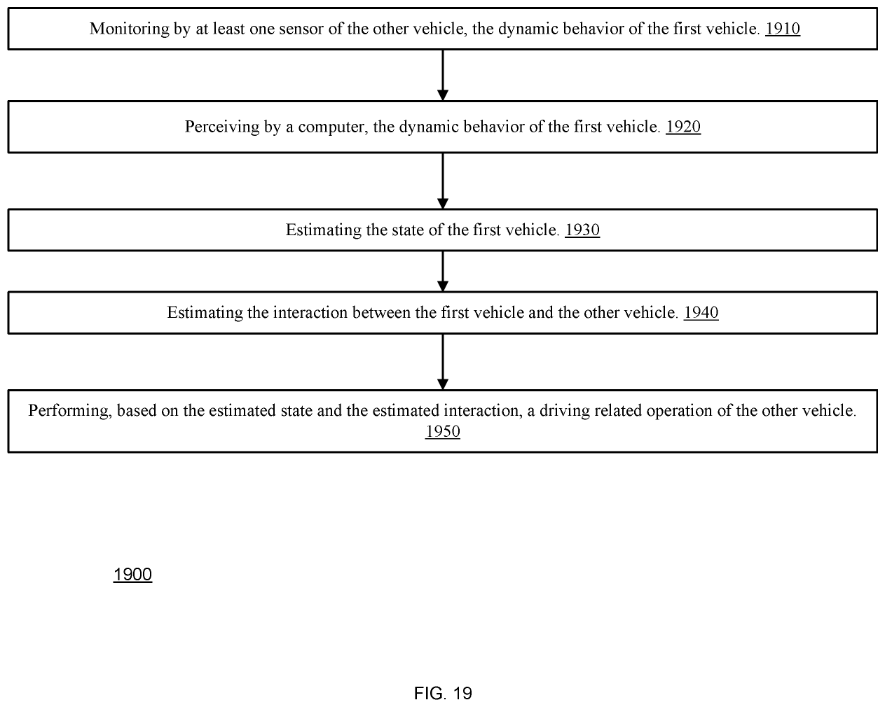

FIG. 19 illustrates a method 1900 for monitoring a vehicle and operating another vehicle.

Method 1900 may include steps 1910, 1920, 1930 and 1940.

Step 1910 may include monitoring by at least one sensor of the other vehicle, the dynamic behavior of the first vehicle.

Step 1920 may include perceiving by a computer, the dynamic behavior of the first vehicle.

Step 1930 may include estimating the state of the first vehicle. Such estimation may be based on analyzing together the behavior of dynamic (the other vehicle) and static objects (the driving free space) and checking whether they match a known pattern of driving (drunk driving, inching into traffic). One algorithm for determining the relationship between the behavior of dynamic and static objects, and patterns of behavior, is to use a deep neural network to learn that relationship.

Step 1940 may include estimating the interaction between the first vehicle and the other vehicle.

Step 1950 may include performing, based on the estimated state and the estimated interaction, a driving related operation of the other vehicle.

The estimating the state of the first vehicle may include estimating the state of the driver.

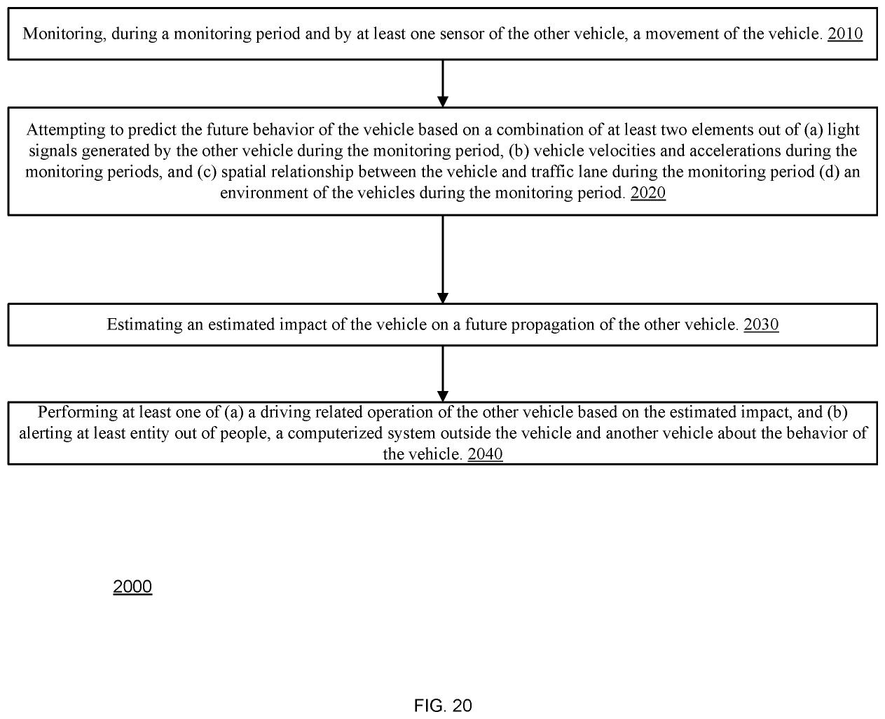

FIG. 20 illustrates a method 2000 for estimating a future behavior of a vehicle and operating another vehicle.

Method 2000 may include steps 2010, 2020, 2030 and 2040.

Step 2010 may include monitoring, during a monitoring period and by at least one sensor of the other vehicle, a movement of the vehicle.

Step 2020 may include attempting to predict the future behavior of the vehicle based on a combination of at least two elements out of (a) light signals generated by the other vehicle during the monitoring period, (b) vehicle velocities and accelerations during the monitoring periods, and (c) spatial relationship between the vehicle and traffic lane during the monitoring period (d) an environment of the vehicles during the monitoring period.

Step 2020 may include selecting, out of multiple vehicle behavior patterns, a selected vehicle behavior pattern; wherein the selecting is based on the monitored movement of the vehicle. Such selection may be based on a deep neural network that is used to learn and classify the multiple vehicle behaviors.

The selecting may include finding a best matching vehicle behavior pattern.

The selecting may include comparing between values of the at least two elements and between values of the at least two elements that are associated with the multiple vehicle behavior patterns.

The multiple vehicle behavior patterns may include (a) maintaining in a current lane, (b) exit the current lane and enter a lane of the other vehicle, (c) exit the current lane without entering the lane of the other vehicle, and (d) stop the vehicle.

Step 2030 may include estimating an estimated impact of the vehicle on a future propagation of the other vehicle.

Step 2040 of performing at least one of (a) a driving related operation of the other vehicle based on the estimated impact, and (b) alerting at least entity out of people, a computerized system outside the vehicle and another vehicle about the behavior of the vehicle.

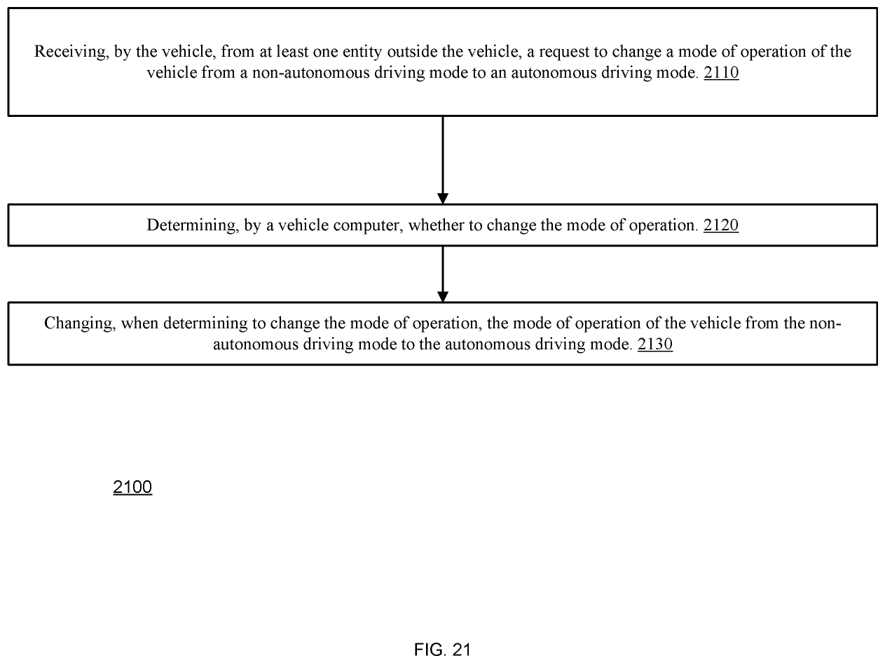

FIG. 21 illustrates a method 2100 for operating a vehicle.

Method 2100 may include steps 2110, 2120 and 2130.

Step 2110 may include receiving, by the vehicle, from at least one entity outside the vehicle, a request to change a mode of operation of the vehicle from a non-autonomous driving mode to an autonomous driving mode.

The at least one entity outside the vehicle may be a person or a vehicle or any other computerized system—such as a control system.

Step 2120 may include determining, by a vehicle computer, whether to change the mode of operation.

Step 2130 may include changing, when determining to change the mode of operation, the mode of operation of the vehicle from the non-autonomous driving mode to the autonomous driving mode.

The determining may be based on a number of requests to change the mode of operation that were received during a time window.

The request may include a risk indication associated with a continuation of the non-autonomous driving mode, and the determining is responsive to the risk indication.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

However, other modifications, variations and alternatives are also possible. The specifications and drawings are, accordingly, to be regarded in an illustrative rather than in a restrictive sense.

The phrase “may be X” indicates that condition X may be fulfilled. This phrase also suggests that condition X may not be fulfilled.

The terms “including”, “comprising”, “having”, “consisting” and “consisting essentially of” are used in an interchangeable manner. For example—any method may include at least the steps included in the figures and/or in the specification, only the steps included in the figures and/or the specification. The same applies to the pool cleaning robot and the mobile computer.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

In the foregoing specification, the invention has been described with reference to specific examples of embodiments of the invention. It will, however, be evident that various modifications and changes may be made therein without departing from the broader spirit and scope of the invention as set forth in the appended claims.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

The invention may also be implemented in a computer program product that is non-transitory that stores instructions that may form a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a computer program product that is non-transitory. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as flash memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one as or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements the mere fact that certain measures are recited in mutually different claims does not indicate that a combination of these measures cannot be used to advantage.

Any system, apparatus or device referred to this patent application includes at least one hardware component.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

Any combination of any component of any component and/or unit of a system that is illustrated in any of the figures and/or specification and/or the claims may be provided.

Any combination of any system illustrated in any of the figures and/or specification and/or the claims may be provided.

Any combination of steps, operations and/or methods illustrated in any of the figures and/or specification and/or the claims may be provided.

Any combination of operations illustrated in any of the figures and/or specification and/or the claims may be provided.

Any combination of methods illustrated in any of the figures and/or specification and/or the claims may be provided.

We claim:

1. A method for operating a vehicle, the method comprises:
sensing, by at least one sensor of the vehicle, an environment of the vehicle, the environment comprises a dynamic object;
estimating an estimated impact of the dynamic object on a future propagation of the vehicle; wherein the estimating is responsive to information that is stored in a dynamic database, wherein the information is about an estimated behavior of the dynamic object; and
performing a driving related operation of the vehicle based on the estimated impact.

2. The method according to claim 1 wherein the sensing occurs at a certain location, and wherein the estimated behavior of the dynamic object is based on behaviors of other dynamic objects at the certain location, wherein information about the behaviors of the other dynamic objects at the certain location is stored in the dynamic database.

3. The method according to claim 1 wherein the estimated behavior of the dynamic object is based on behaviors of other dynamic objects at environments that are similar to the environment of the vehicle.

4. The method according to claim 1, wherein the dynamic object is another vehicle.

5. The method according to claim 4, wherein the information is about an expected driving pattern of the other vehicle.

6. The method according to claim 1, wherein the dynamic object is a person.

7. The method according to claim 1, comprising reporting the sensing of the dynamic object.

8. The method according to claim 1 wherein the performing of the driving related operation of the vehicle comprises autonomously driving the vehicle.

9. The method according to claim 1 wherein the performing of the driving related operation of the vehicle comprises changing a mode of operation of the vehicle between an autonomous driving mode and a non-autonomous driving mode.

10. The method according to claim 1 wherein the performing of the driving related operation of the vehicle comprises generating a driver perceivable alert.

11. The method according to claim 1 wherein the performing of the driving related operation of the vehicle comprises reducing a velocity of the vehicle.

12. The method according to claim 1 wherein the performing of the driving related operation of the vehicle comprises changing the future propagation of the vehicle in order to acquire a better sensing of the dynamic object.

13. The method according to claim 1 comprising detecting changes between a sensed content of the environment and an expected content of the environment.

14. The method according to claim 13, comprising determining whether to report at least one of the changes.

15. The method according to claim 13, comprising reporting an absence of a movable object from a road included in the environment.

16. The method according to claim 1, comprising reporting the estimated impact of the dynamic object on the future propagation of the vehicle.

17. The method according to claim 1, comprising receiving or generating a risk map and updating the risk map with the estimated impact of the dynamic object on the future propagation of the vehicle.

18. The method according to claim 1, wherein the sensing comprises sensing signals associated with a group of points of interest within the environment by a vehicle sensor.

19. The method according to claim 18, wherein the sensing is preceded by retrieving information about locations of the points of interest of the group.

20. The method according to claim 18, wherein the sensing is followed by estimating a quality of the points of interest of the group.

21. The method according to claim 18, wherein the sensing is followed by reporting a quality of the points of interest of the group.

22. The method according to claim 18, wherein the sensing comprising sensing signals associated with at least one point of interest that is relevant within reoccurring time windows and is irrelevant outside the reoccurring time windows.

23. The method according to claim 18, wherein the sensing comprising sensing signals associated with at least one point of interest that is relevant within one or more time windows and is irrelevant outside the one or more time windows.

24. The method according to claim 1, wherein the sensing comprises collecting signals from multiple groups of points of interest within the environment by a multiple types of vehicle sensors.

25. The method according to claim 24, wherein the multiple types of vehicle sensors comprise a camera, a light detection and ranging sensor and a radio frequency radar.

26. The method according to claim 25, comprising determining at least one point of interest for at least one type of vehicle sensor based on information obtained by at least one other type of vehicle sensor.

27. The method according to claim 1, wherein the sensing comprises selecting which type of vehicle sensor to use for sensing the environment of the vehicle based on at least one out of an actual or estimated status of the environment.

28. The method according to claim 1, comprising transmitting information about the environment to a computerized system that is positioned outside the vehicle.

29. The method according to claim 28, comprising generating the information about the environment by applying privacy protection measures.

30. The method according to claim 29, wherein the applying of privacy protection measures comprises masking at least one out of vehicle identifying information and people identifying information.

31. The method according to claim 1, comprising reporting a sensed movement of the dynamic object.

32. A method for of a vehicle, the method comprises: repeating, for each location out of multiple locations, the steps of:
selecting which type of vehicle sensor, out of multiple types of vehicle sensors, to use for sensing an environment of the vehicle when the vehicle is located at the location;
and using at least one selected type of vehicle sensor to sense the environment of the vehicle when the vehicle is located at the location; wherein the using comprises sensing signals associated with multiple points of interest within the environment.

33. The method according to claim 32 wherein the multiple types of vehicle sensors comprise a camera, a light detection and ranging (lidar) sensor and a radio frequency radar.

34. The method according to claim 32 comprising estimating a quality of at least some of the multiple points of interest.

35. A method for maintaining a dynamic database, the method comprises:
receiving, from a first plurality of vehicles and information about different locations of the multiple vehicles;
maintaining the dynamic database, wherein the dynamic database comprises statistics related to behaviors of dynamic objects within the different locations; and
distributing relevant portions of the dynamic database to a second plurality of vehicles.

36. The method according to claim 35 wherein at least some of the statistics are time sensitive.

37. The method according to claim 35 wherein the maintaining comprises generating and updating the dynamic database.

38. The method according to claim 35 wherein the dynamic objects comprise vehicles.

39. The method according to claim 35 wherein the dynamic objects comprise people.

40. The method according to claim 35 the dynamic objects comprise people and vehicles.

41. The method according to claim 35 wherein the statistics is indicative of a time sensitive distribution of vehicle types in a lane.

42. The method according to claim 35 wherein the statistics is related to behavior of dynamic objects within one or more junctions.

43. The method according to claim 35 wherein the statistics is related to relationship between a state of one or more traffic lights positioned in one or more junctions and a behavior of dynamic objects within the one or more junctions.

44. The method according to claim 35 wherein the statistics is related to speeds at different direction within one or more junctions.

45. The method according to claim 35 wherein the statistics is related to behaviors of different types of vehicles within one or more junctions.

46. The method according to claim 35 wherein the statistics is related to behaviors of different types of vehicles and one or more people within one or more junction.

47. The method according to claim 35 wherein the statistics is related to behaviors of dynamic objects selected out of vehicles and people in a vicinity of one or more building

48. The method according to claim 35 wherein the receiving of the information comprises receiving raw data sensed by vehicle sensors of at least one vehicle of the first plurality of vehicles and receiving event information from at least one other vehicle of the first plurality of vehicles; wherein a size of the event information is smaller than a size of the raw data.

49. The method according to claim 35 comprising classifying the different locations to prototype locations and maintaining statistics per prototype location.

50. The method according to claim 35 comprising maintaining statistics per locations that are similar to each other.

51. The method according to claim 35 comprising classifying locations to classes and maintaining statistics per class, wherein a classification of at least one class is responsive to an amount of data obtained in relation to one or more locations that belong to the class.

52. The method according to claim 35 comprising maintaining statistics per locations that comprise traffic lanes, junctions, and buildings.

53. The method according to claim 35 wherein the maintaining comprises applying deep learning to determine the statistics.

54. The method according to claim 35 comprising receiving information from a vehicle about a mismatch between information sensed by the vehicle about a location of the different locations and information of the dynamic database about the location.

55. The method according to claim 35 comprising receiving information from a vehicle about a mismatch between an actual behavior of a dynamic object within a location and statistics, included in the dynamic database, about the dynamic object within the location.

56. The method according to claim 35 comprising requesting a vehicle to provide information regarding a new location not included in the multiple locations.

57. The method according to claim 35 comprising requesting a vehicle to provide information regarding a quality of one or more points of interest illuminated by the vehicle.

58. The method according to claim 35 comprising requesting a vehicle to provide information regarding a behavior of one or more dynamic objects within one or more locations within one or more future time windows.

59. The method according to claim 35 comprising requesting a vehicle to change a position of the vehicle to a certain position and requesting the vehicle to obtain information from the certain location.

60. The method according to claim 35 comprising maintaining in the dynamic database points of interest information about groups of points of interests, wherein each group is associated with a location of the different locations.

61. The method according to claim 60 wherein two or more groups are associated with a same location and with two or more types of vehicle sensors.

62. The method according to claim 60 wherein the point of interest information comprises location information about an absolute location of the points of interest.

63. The method according to claim 60 wherein the points of interest comprises static points of interest on static objects and at least one out of (a) static points of interest on dynamic objects, and (b) dynamic points of interest on static objects.

64. The method according to claim 60 wherein the points of interest information comprises two-dimension location information and distance information.

65. The method according to claim 64 wherein each point of interest represents a segment of the object and wherein the distance information represents distances to multiple parts of the segment.

66. The method according to claim 60 comprising requesting a vehicle to provide information regarding points of interest.

67. The method according to claim 35 comprising determining a relevant portion of the dynamic database to be sent to vehicle of the second plurality of vehicles based on a location of the vehicle and a cost associated with a transmission to the vehicle.

68. A method for assisting in an update of dynamic database, the method comprises:
receiving, by a vehicle, a portion of the dynamic database; wherein the dynamic database comprises statistics related to behaviors of dynamic objects within the different locations;
searching for a mismatch between the content of the portion of the dynamic database and sensed information that is sensed by the vehicle; and
reporting the mismatch to a computerized entity that participates in a maintaining of the dynamic database.

69. The method according to claim 68 wherein the dynamic data base comprises information about groups of points of interests, wherein each group is associated with a location of the different locations.

70. The method according to claim 69 comprising sending information about a quality of one or more points of interest to the database.

71. A computer program product that stores instructions that once executed by a computerized system that is installed in a vehicle, causes the computerized system to:
sense, by at least one sensor of the computerized system, an environment of the vehicle, the environment comprises a dynamic object;
estimate an estimated impact of the dynamic object on a future propagation of the vehicle; wherein the estimating is responsive to information that is stored in a dynamic database, wherein the information is about an estimated behavior of the dynamic object; and
perform a driving related operation of the vehicle based on the estimated impact.

72. A computer program product that stores instructions that once executed by a computerized system that is installed in a vehicle, causes the computerized system to:
repeat, for each location out of multiple locations, the steps of:
selecting which type of vehicle sensor, out of multiple types of vehicle sensors, to use for sensing an environment of the vehicle when the vehicle is located at the location; and
using at least one selected type of vehicle sensor to sense the environment of the vehicle when the vehicle is located at the location;
wherein the using comprises sensing signals associated with multiple points of interest within the environment.

73. A computer program product that stores instructions that once executed by a computerized system that is positioned outside a vehicle, causes the computerized system to:
receive, from a first plurality of vehicles and information about different locations of the multiple vehicles;
maintain the dynamic database, wherein the dynamic database comprises statistics related to behaviors of dynamic objects within the different locations; and
distribute relevant portions of the dynamic database to a second plurality of vehicles.

74. A computer program product that stores instructions that once executed by a computerized system that is positioned outside a vehicle, causes the computerized system to:
receive a portion of the dynamic database; wherein the dynamic database comprises statistics related to behaviors of dynamic objects within the different locations;
search for a mismatch between the content of the portion of the dynamic database and sensed information that is sensed by the vehicle; and
report the mismatch to a computerized entity that participates in a maintaining of the dynamic database.

75. A computerized system that is installed in a vehicle, wherein the computerized system comprises:
at least one sensor that is configured to sense an environment of the vehicle, the environment comprises a dynamic object; and
a processor that is configured to (a) estimate an estimated impact of the dynamic object on a future propagation of the vehicle; wherein the estimating is responsive to information that is stored in a dynamic database, wherein the information is about an estimated behavior of the dynamic object; and (b) perform a driving related operation of the vehicle based on the estimated impact.

76. A computerized system that is installed in a vehicle, wherein the computerized system comprises a processor and multiple types of sensors;
wherein the computerized system is configured to repeat, for each location out of multiple locations, the steps of:
selecting, by the processor, which type sensor, out of the multiple types of sensors, to use for sensing an environment of the vehicle when the vehicle is located at the location; and
use at least one selected type of sensor to sense the environment of the vehicle when the vehicle is located at the location;
wherein the using comprises sensing signals associated with multiple points of interest within the environment.

77. A computerized system that positioned outside a vehicle, that comprises a communication unit and a processor;
wherein the communication unit is configured to receive, from a first plurality of vehicles and information about different locations of the multiple vehicles;
wherein the processor is configured to maintain the dynamic database, wherein the dynamic database comprises statistics related to behaviors of dynamic objects within the different locations; and
wherein the communication unit is configured to distribute relevant portions of the dynamic database to a second plurality of vehicles.

78. A computerized system that positioned outside a vehicle, the computerized system comprises a communication unit and a processor;
wherein the communication unit is configured to receive a portion of the dynamic database;
wherein the dynamic database comprises statistics related to behaviors of dynamic objects within the different locations;
wherein the processor is configured to search for a mismatch between the content of the portion of the dynamic database and sensed information that is sensed by the vehicle; and
wherein the communication unit is configured to report the mismatch to a computerized entity that participates in a maintaining of the dynamic database.

79. A method for monitoring a vehicle and operating another vehicle, the method comprises:
monitoring, by at least one sensor of the other vehicle, a movement of the vehicle; wherein the vehicle differs from the other vehicle;
estimating, by a computer of the other vehicle, based on the movement of the first vehicle and a model of the vehicle, an estimated interaction between a driver of the vehicle and the vehicle;
determining a status of the driver based on the estimated interaction;
estimating an estimated impact of the vehicle on a future propagation of the other vehicle; and
performing a driving related operation of the other vehicle based on the estimated impact.

80. The method according to claim 79 wherein the estimating comprises estimating an interaction between the driver and a steering wheel of the vehicle.

81. The method according to claim 79 wherein the determining comprises applying at least one out of a drowsiness detection process, a fatigue detection process and a driving while intoxicated detection process.

82. The method according to claim 79 wherein the determining comprises applying a drowsiness detection process, a fatigue detection process and a driving while intoxicated detection process.

83. The method according to claim 79 further comprising autonomously generating an alert that is perceivable by the driver of the vehicle.

84. The method according to claim 79 further comprising autonomously generating an alert that is perceivable by one or more other vehicles.

85. The method according to claim 79 further comprising informing a computerized system outside the vehicle about the status of the driver.

86. The method according to claim 79 further comprising requesting the vehicle, by the other vehicle, to change a mode of operation of the other vehicle from a non-autonomous driving mode to an autonomous driving mode.

87. A method for monitoring a vehicle and operating another vehicle, the method comprises:
monitoring by at least one sensor of the other vehicle, a dynamic behavior of a vehicle; wherein the vehicle differs from the other vehicle;
perceiving by a computer, a dynamic behavior of the vehicle;
estimating the state of the vehicle;
estimating the interaction between the vehicle and the other vehicle, and
based on the estimated state and the estimated interaction, performing a driving related operation of the other vehicle.

88. The method according to claim 87 wherein estimating the state of the vehicle comprises estimating the state of the driver

89. A method for estimating a future behavior of a vehicle and operating another vehicle, the method comprises:
monitoring, during a monitoring period and by at least one sensor of the other vehicle, a movement of the vehicle; wherein the vehicle differs from the other vehicle;
attempting to predict a future behavior of the vehicle based on a combination of at least two elements out of (a) light signals generated by the other vehicle during the monitoring period, (b) vehicle velocities and accelerations during the monitoring periods, and (c) spatial relationship between the vehicle and traffic lane during the monitoring period (d) an environment of the vehicles during the monitoring period;
estimating an estimated impact of the vehicle on a future propagation of the other vehicle; and
performing a driving related operation of the other vehicle based on the estimated impact.

90. The method according to claim 89 wherein the attempting comprises selecting, out of multiple vehicle behavior patterns, a selected vehicle behavior pattern; wherein the selecting is based on the monitored movement of the vehicle.

91. The method according to claim 90 wherein the selecting comprises finding a best matching vehicle behavior pattern.

92. The method according to claim 90 wherein the selecting comprises comparing between values of the at least two elements and between values of the at least two elements that are associated with the multiple vehicle behavior patterns.

93. The method according to claim 90 wherein the multiple vehicle behavior patterns comprise (a) maintaining in a current lane, (b) exit the current lane and enter a lane of the other vehicle, (c) exit the current lane without entering the lane of the other vehicle, and (d) stop the vehicle.

94. The method according to claim 89 wherein the estimating is responsive to information that is stored in a dynamic database,

95. A method for operating a vehicle, the method comprises:
receiving, by the vehicle, from at least one entity outside the vehicle, a request to change a mode of operation of the vehicle from a non-autonomous driving mode to an autonomous driving mode;
determining, by a vehicle computer, whether to change the mode of operation;
and when determining to change the mode of operation then changing the mode of operation of the vehicle from the non-autonomous driving mode to the autonomous driving mode.

96. The method according to claim 95 wherein the determining is based on a number of requests to change the mode of operation that were received during a time window.

97. The method according to claim 95 wherein the request comprises a risk indication associated with a continuation of the non-autonomous driving mode; wherein the determining is responsive to the risk indication.

98. The method according to claim 95 wherein the at least one entity outside the vehicle comprises at least one person.

99. The method according to claim 95 wherein the at least one entity outside the vehicle comprises at least one other vehicle.

100. A computer program product that stores instructions that once executed by a computerized system that is positioned inside an other vehicle, causes the computerized system to:
monitor a movement of a vehicle; wherein the vehicle differs from the other vehicle;
estimate, based on the movement of the vehicle and a model of the vehicle, an estimated interaction between the driver and the vehicle;
determine a status of the driver based on the estimated interaction;
estimate an estimated impact of the vehicle on a future propagation of the other vehicle; and
perform a driving related operation of the other vehicle based on the estimated impact.

101. A computer program product that stores instructions that once executed by a computerized system that is positioned inside an other vehicle, causes the computerized system to:
monitor a dynamic behavior of a vehicle; wherein the vehicle differs from the other vehicle;
perceive a dynamic behavior of the vehicle;
estimate a state of the vehicle;
estimate an interaction between the vehicle and the other vehicle, and
based on the estimated state and the estimated interaction, perform a driving related operation of the other vehicle

102. A computer program product that stores instructions that once executed by a computerized system that is positioned inside an other vehicle, causes the computerized system to:
monitor, during a monitoring period, a movement of a vehicle; wherein the vehicle differs from the other vehicle;
attempt to predict a future behavior of the vehicle based on a combination of at least two elements out of (a) light signals generated by the other vehicle during the monitoring period, (b) vehicle velocities and accelerations during the monitoring periods, and (c) spatial relationship between the vehicle and traffic lane during the monitoring period (d) an environment of the vehicles during the monitoring period; estimating an estimated impact of the vehicle on a future propagation of the other vehicle; and
perform a driving related operation of the other vehicle based on the estimated impact.

103. A computer program product that stores instructions that once executed by a computerized system that is positioned inside a vehicle, causes the computerized system to:
receive, from at least one entity outside the vehicle, a request to change a mode of operation of the vehicle from a non-autonomous driving mode to an autonomous driving mode;
determine whether to change the mode of operation; and
when determining to change the mode of operation then change the mode of operation of the vehicle from the non-autonomous driving mode to the autonomous driving mode.

104. A computerized system that is installed in an other vehicle, wherein the computerized system comprises a processor and one or more sensors;
wherein the one or more sensors are configured to monitor a movement of a vehicle; wherein the vehicle differs from the other vehicle;
wherein the processor is configured to:
estimate, based on the movement of the vehicle and a model of the vehicle, an estimated interaction between the driver and the vehicle;
determine a status of the driver based on the estimated interaction;
estimate an estimated impact of the vehicle on a future propagation of the other vehicle; and
assist in performing a driving related operation of the other vehicle based on the estimated impact.

105. A computerized system that is installed in an other vehicle, wherein the computerized system comprises a processor and one or more sensors;
wherein the one or more sensors are configured to monitor a dynamic behavior of a vehicle; wherein the vehicle differs from the other vehicle;
wherein the processor is configured to:
perceive a dynamic behavior of the vehicle;
estimate a state of the vehicle;
estimate an interaction between the vehicle and the other vehicle, and
based on the estimated state and the estimated interaction, assist in
performing a driving related operation of the other vehicle

106. A computerized system that is installed in an other vehicle, wherein the computerized system comprises a processor and one or more sensors;
wherein the one or more sensors are configured to monitor, during a monitoring period, a movement of a vehicle; wherein the vehicle differs from the other vehicle;
wherein the processor is configured to:
attempt to predict a future behavior of the vehicle based on a combination of at least two elements out of (a) light signals generated by the other vehicle during the monitoring period, (b) vehicle velocities and accelerations during the monitoring periods, and (c) spatial relationship between the vehicle and traffic lane during the monitoring period (d) an environment of the vehicles during the monitoring period;
estimate an estimated impact of the vehicle on a future propagation of the other vehicle; and
assist in performing a driving related operation of the other vehicle based on the estimated impact.

107. A computerized system that is installed in a vehicle, wherein the computerized system comprises a processor and a communication unit;
wherein the communication unit is configured to receive, from at least one entity outside the vehicle, a request to change a mode of operation of the vehicle from a non-autonomous driving mode to an autonomous driving mode;
wherein the processor is configured to determine whether to change the mode of operation; and when determining to change the mode of operation then change the mode of operation of the vehicle from the non-autonomous driving mode to the autonomous driving mode.
